(19) United States
(12) Patent Application Publication
(10) Pub. No.: US 2025/0363097 A1
(43) Pub. Date: Nov. 27, 2025

(54) COMPACT SEARCH CLIENT FOR AUGMENTED SEARCH

(71) Applicant: Perplexity AI, Inc., San Francisco, CA (US)

(72) Inventors: Yury Sobolev, San Francisco, CA (US); Johnny Ho, New York, NY (US); Kevin Hu, Santa Clara, CA (US); Nick Jalbert, Berkeley, CA (US); Henry Modisett, Vancouver (CA); Aravind Srinivas, San Francisco, CA (US); Nikhil Thota, San Francisco, CA (US); Alexandr Yarats, Minneapolis, MN (US); Denis Yarats, Minneapolis, MN (US)

(21) Appl. No.: 19/217,672

(22) Filed: May 23, 2025

Related U.S. Application Data
(60) Provisional application No. 63/651,240, filed on May 23, 2024.

(51) Int. Cl. G06F 16/242; G06F 16/22; G10L 15/22

(52) U.S. Cl. CPC G06F 16/2423; G06F 16/22; G06F 16/243; G10L 15/22

(57) ABSTRACT

A compact search client for accessing an augmented search engine is provided. The compact search client receives a verbal query for a search from a user. The compact search client communicates the verbal query to the augmented search engine. The augmented search engine determines a next search phase using a search state database. The augmented search engine generates a search query using the query and determines search results by querying search indexes with the search query and stores these results in the search state database. The augmented search engine generates a search summary using the query and the search results, and provides the search summary as a verbal search summary to the user via the compact search client.

### CROSS-REFERENCE TO RELATED APPLICATIONS

This patent application claims priority to U.S. Provisional Patent Application Ser. No. 63/651,240, filed May 23, 2025, which is incorporated herein by reference in its entirety.

### TECHNICAL FIELD

Examples of the disclosure relate generally to search engines and, more specifically, to executing augmented searches using a dedicated compact search client.

### BACKGROUND

Users use search engines to find information on Wide Area Networks. Traditional search engines do not provide sufficient interactivity with a user to provide relevant search results efficiently.

### BRIEF SUMMARY

Certain embodiments are directed to a system comprising a memory and at least one processor configured to: receive an audio query of a verbal input captured by a microphone of a compact search client; generate a search query based at least in part on output of a speech-to-text machine learning model using the audio query as input; generate a search summary based at least in part on search results determined from the search query; convert the search summary into an audio search summary using a text-to-speech machine learning model; and communicating, over a network, the audio search summary to the compact search client to cause the compact search client to output the audio search summary using an audio speaker.

In certain embodiments, the at least one processor is configured to: store the search query in a search state database; determine, using the search state database, that additional user input is needed to determine the search results; generate an audio prompt; communicate, over the network, the audio prompt to the compact search client to cause the compact search client to output the audio prompt using the audio speaker. In various embodiments, determining that additional user input is needed to determine the search results, the at least one processor executes a search state classification model.

In various embodiments, generating the audio prompt comprises executing a Large Language Model (LLM). In certain embodiments, generating the search query comprises executing a Large Language Model (LLM). In various embodiments, generating the search summary comprises executing a Large Language Model (LLM). In certain embodiments, generating the search summary comprises determining the search results using an internal index. In various embodiments, generating the search summary comprises determining the search results at least in part by querying an external search engine and receiving output from the external search engine.

Certain embodiments are directed to a method comprising receiving, by at least one processor, an audio query of a verbal input captured by a microphone of a compact search client; generating a search query based at least in part on output of a speech-to-text machine learning model using the audio query as input;

generating a search summary based at least in part on search results determined from the search query; converting the search summary into an audio search summary using a text-to-speech machine learning model; and communicating, over a network, the audio search summary to the compact search client to cause the compact search client to output the audio search summary using an audio speaker.

In certain embodiments, the method further comprises storing the search query in a search state database; determining, using the search state database, that additional user input is needed to determine the search results; generating an audio prompt; communicating, over the network, the audio prompt to the compact search client to cause the compact search client to output the audio prompt using the audio speaker; receiving an audio response generated by the compact search client based at least in part on a verbal response captured by a microphone after the compact search client output the audio prompt using the audio speaker; and wherein generating the search query is further based at least in part on output of the speech-to-text machine learning model using the audio query and the audio response as input.

In some embodiments, determining that additional user input is needed to determine the search results comprises executing a search state classification model. In certain embodiments, generating the audio prompt comprises executing a Large Language Model (LLM). In some embodiments, generating the search query comprises executing a Large Language Model (LLM). In various embodiments, generating the search summary comprises executing a Large Language Model (LLM). In some embodiments, generating the search summary comprises determining the search results using an internal index.

In some embodiments, generating the search summary comprises determining the search results at least in part by querying an external search engine and receiving output from the external search engine.

Certain embodiments are directed to a method comprising capturing a verbal query for a search using a microphone; communicating audio data of the verbal query over a network to an augmented search engine to cause the augmented search engine to generate a search query using a speech-to-text machine learning model; receiving, from the augmented search engine, an audio search summary, the audio search summary generated using a search summary and a text-to-speech machine learning model, the search summary generated using search results determined by the search query; and generating an audio signal for the audio search summary using an audio speaker.

In certain embodiments, the method further comprises receiving, from the augmented search engine, an audio prompt requesting additional user input, the audio prompt generated for the user using a search state database including the search query; generating an audio signal for the audio prompt using the audio speaker; capturing a verbal response using the microphone; and communicating an audio response of the verbal response, to the augmented search engine over the network.

In some embodiments, communicating the audio response occurs before receiving the audio search summary, and wherein the search query is generated based at least in part on the audio response.

### BRIEF DESCRIPTION OF THE DRAWINGS

The present disclosure will be understood more fully from the detailed description given below and from the accompanying drawings of various examples of the disclosure.

FIG. 1 is a system diagram of a system for performing an augmented search, according to some examples.

FIG. 2 is an architecture diagram of a compact search client used in conjunction with an augmented search engine, according to some examples.

FIG. 3 is a sequence diagram of an augmented search method for performing an augmented search, according to some examples.

FIG. 4 is a process flow diagram of an augmented search method for performing an augmented search, according to some examples.

FIG. 5 is an architecture diagram of a router for performing an augmented search, according to some examples.

FIG. 6 is an architecture diagram of an aggregator for performing an augmented search, according to some examples.

FIG. 7 is an architecture diagram of a summarizer for performing an augmented search, according to some examples.

FIG. 8A illustrates a machine-learning pipeline, according to some examples.

FIG. 8B illustrates training and use of a machine-learning model, according to some examples.

FIG. 9 illustrates a diagrammatic representation of a machine in the form of a computer system within which a set of instructions may be executed for causing the machine to perform any one or more of the methodologies discussed herein, according to some examples.

### DETAILED DESCRIPTION

The Internet has ushered in an era where information is both a valuable commodity and an overwhelming flood. Users turn to digital platforms to seek answers, insights, and data for a myriad of purposes ranging from academic research to personal curiosity. However, the sheer volume and diversity of information available online pose significant challenges in terms of efficiently locating relevant and accurate data. Traditional search methodologies often fall short in navigating this vast digital landscape, leading to a demand for more sophisticated and user-centric search solutions.

Traditional search engines often present challenges in effectively meeting the diverse requests of users seeking information online. The primary issues stem from limitations in the search process itself, which can lack that intuitiveness and efficiency allows users to easily find the information they seek. Despite advancements in search algorithms and indexing techniques, there remains a gap in how traditional search systems interact with users. These systems frequently fail to fully grasp the subtleties of queries, leading to a search experience that may not deliver results in a manner that is both thorough and easily understood.

Search engines are often accessed over a Wide Area Network (WAN), such as the Internet or the like, using a personal computer or a smartphone. However, a personal computer or a smartphone have components and functionalities that are extraneous to search functions. In addition, a user may wish to access a search engine in a handsfree mode as the user attends to certain tasks. In some instances, a user may be in an environment where a personal computer or smartphone may be at risk of being damaged. Therefore a need exists for a small lightweight dedicated single-purpose device that can access a search engine.

In some examples, an augmented search engine system includes a compact search client and an augmented search engine. The compact search client receives a verbal query from a user, converts it into an audio query, and communicates with the augmented search engine. The compact search client also receives an audio search summary from the augmented search engine and provides it to the user as an audio signal. The augmented search engine receives the audio query from the compact search client, uses a speech-to-text machine learning model to generate a search query, determines search results, and then uses these results to generate a search summary. This summary is converted into an audio search summary using a text-to-speech machine learning model, which is then sent back to the compact search client.

In some examples, the compact search client further handles audio prompts received from the augmented search engine by delivering these prompts to the user and sending user responses back to the augmented search engine. This interaction helps refine the search process based on additional user input.

In some examples, the augmented search engine stores the initial query in a search state database and uses it to determine the next phase of the search. If additional user input is needed, the engine generates an audio prompt based on the stored data, which is communicated to the compact search client and presented to the user.

In some examples, the augmented search engine enhances its search capabilities by employing a Large Language Model (LLM) for generating prompts, search queries, and search summaries, leveraging advanced natural language processing techniques to improve interaction with the user and the relevance of the search results.

In some examples, an augmented search engine generates a summary of search results in an augmented search, offering the feature of improved user comprehension. The augmented search engine can synthesize complex and voluminous search results into concise summaries, aiding users in quickly understanding the essence of the search results without needing to sift through each result individually. This facilitates easier and faster comprehension of the search outcomes.

In some examples, an augmented search engine enhances the user experience by providing summaries that capture the pertinent information from a broad set of search results. Users can quickly grasp the relevance of the search results to their query, leading to higher satisfaction with the search process and potentially increasing the likelihood of users returning to the augmented search engine for future information requirements.

In some examples, an augmented search engine contributes to time and resource efficiency. It streamlines the search process by reducing the time users spend analyzing individual search results. This efficiency benefits users and optimizes the use of computational resources within the augmented search engine, as the engine automates the summarization process that would otherwise require significant manual effort and processing power.

In some examples, an augmented search engine allows for customization and personalization. It can be trained to generate summaries tailored to specific user preferences or query contexts. By learning from user interactions and feedback, the augmented search engine can adapt its summarization techniques to better align with individual user requirements or preferences, offering a more personalized search experience.

In some examples, the scalability of an augmented search engine ensures that it can effectively serve a broad user base with varying information requirements, from simple queries to complex research topics. This scalability is useful for handling a wide range of queries and generating summaries for diverse sets of search results.

In some examples, an augmented search engine maintains quality control and consistency in the summaries it generates. This ensures that users receive reliable and coherent information regardless of the query, which is useful for building user trust in the augmented search engine's ability to provide valuable and accurate summaries.

In some examples, an augmented search engine is designed to extract and highlight insights, trends, or patterns within the search results, adding value by summarizing the content and by providing users with actionable insights derived from the aggregated search results.

In some examples, an augmented search engine effectively reduces information overload for users by condensing the search results into summaries. This reduction helps users focus on the relevant information, making the search process more manageable and less overwhelming.

Other technical features may be readily apparent to one skilled in the art from the following figures, descriptions, and claims.

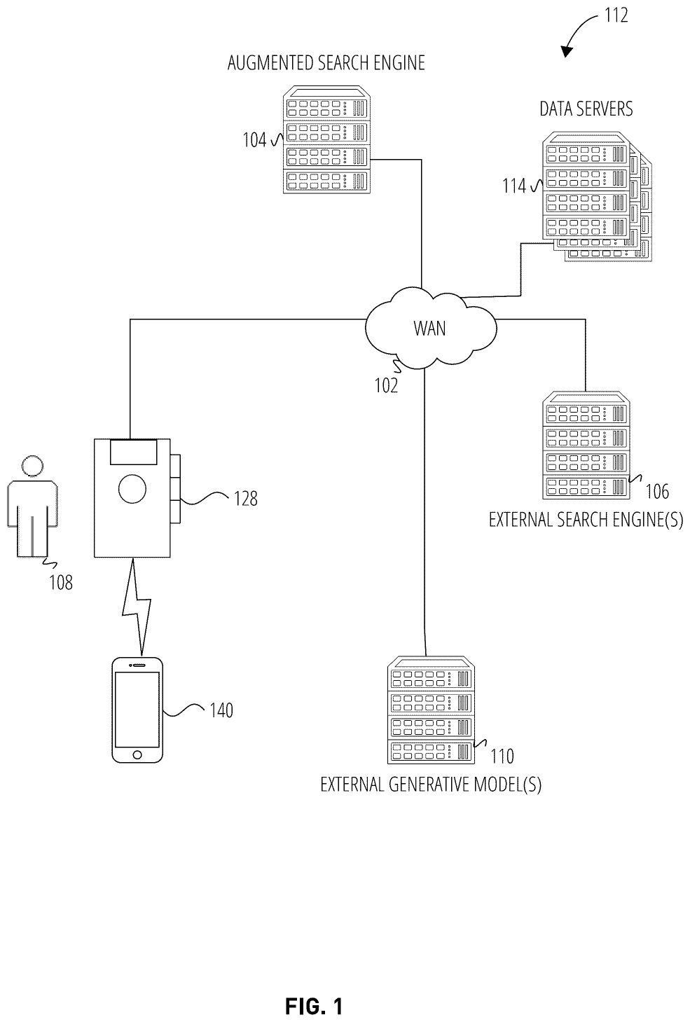

FIG. 1 is a system diagram of an augmented search system 112 for performing an augmented search, according to some examples. An augmented search engine 104 uses the augmented search system 112 to provide an augmented search to a user 108.

An augmented search engine 104 serves as a processing system where queries are received, analyzed, and processed. The augmented search engine 104 is equipped with processes and models that enable the augmented search engine 104 to interpret queries, generate prompts for additional information, and utilize search queries refined by the additional information to search through various indexes and databases for relevant information as described herein.

The user 108 interacts with the augmented search engine 104 through a compact search client 128. The compact search client 128 provides the interface through which a user submits their query and interacts with any subsequent prompts or search results presented by the augmented search engine 104.

In some examples, the compact search client 128 is a streamlined, efficient device focused on providing a seamless and intuitive user experience for interacting with a powerful backend search engine such as the augmented search engine 104. The design of the compact search client 128 emphasizes ease of use, portability, and focused functionality, catering to users who require quick and straightforward access to information.

In some examples, the compact search client 128 is designed to facilitate user interaction with an augmented search engine 104 without the need for extensive onboard computing power. The compact search client 128 is simple and efficient, focusing on specific functionalities to enhance user experience while relying on a backend system of the augmented search engine 104 for processing complex tasks.

In some examples, the augmented search engine 104 is designed with minimal hardware components, which include a microcontroller, a digital microphone, a speaker, and connectivity modules such as Wi-Fi and Bluetooth. This design choice reduces manufacturing costs and power consumption, making the compact search client 128 lightweight and portable.

In some examples, the compact search client 128 receives verbal queries from the user. The compact search client 128 comprises a digital microphone used to capture these queries and to convert them into digital signals that can be processed further.

In some examples, after capturing the verbal query, the compact search client 128 sends this data to the augmented search engine 104 via an audio format. The compact search client 128 also receives audio responses (search summaries) from the augmented search engine 104, which the compact search client 128 plays back to the user 108 through a speaker. This audio-based interaction simplifies the user interface, making the compact search client 128 accessible and easy to use.

In some examples, the compact search client 128 uses Wi-Fi and Bluetooth for connectivity. Accordingly, the compact search client 128 comprises a network device providing wireless connectivity via Wi-Fi and Bluetooth. Bluetooth is used for initial setup processes, such as configuring network settings through a smartphone app or the like. Wi-Fi connectivity enables the compact search client 128 to communicate with the augmented search engine 104, sending queries and receiving responses.

In some examples, the compact search client 128 includes basic input/output components such as buttons and LED indicators. These are used for initiating queries, adjusting volume, and providing visual feedback about the status of the compact search client 128, such as battery level, connection status, and the like.

In some examples, the compact search client 128 is designed as a portable device that users can place on a desk or carry around. A function of the compact search client 128 is to serve as an interface between the user 108 and the augmented search engine 104, making the compact search client 128 a dedicated tool for information retrieval without the distractions or complexities of multifunctional devices such as smartphones, computers, and the like.

The augmented search engine 104 is connected to a Wide Area Network (WAN) 102, which facilitates communication between the augmented search engine 104, the compact search client 128, and external resources. In some examples, WAN 102 may be of a variety of network types designed to extend over large geographical areas, facilitating communication, data exchange, and resource sharing across distant locations such as, but not limited to, the Internet, a corporate network, a research and education network, a telecommunication network, and the like. The WAN 102 enables the augmented search engine 104 to access one or more external search engines 106 and one or more external generative models 110, expanding the scope of the search beyond the internal capabilities and databases of the augmented search engine 104.

In some examples, the augmented search engine 104 and the one or more external search engines 106 access one or more data servers 114 via the WAN 102. This allows the augmented search engine 104 to offer focused augmented searches. The one or more data servers 114 may include various types of data sources such as, but not limited to:
Web Servers: These servers host websites and are responsible for accepting requests from clients (web browsers) and serving them web pages. For instance, the Apache HTTP Server and Microsoft's Internet Information Services (IIS) are examples of web servers that can host searchable content.
Database Servers: These are specialized servers designed to host database services, where structured data can be stored, queried, and retrieved. Examples include MySQL, PostgreSQL, Oracle Database, and Microsoft SQL Server. These servers can support complex queries and are often used by websites and applications to store user data, product information, and other searchable content.
File Servers: File servers are used to store and manage files in a network. They allow users to share and access files across the network. Examples include servers hosting shared drives within an organization or cloud-based storage services like Google Drive and Dropbox, where files and documents can be searched and retrieved.
Content Management Systems (CMS): These are platforms that allow users to create, manage, and modify digital content without using specialized technical knowledge. Examples include WordPress, Drupal, and Joomla. A CMS typically runs on a web server and stores content in a database server, making the content searchable through the website's search function.
Cloud Storage Services: These services offer storage and retrieval of data over the internet. Examples include Amazon S3, Microsoft Azure Storage, and Google Cloud Storage. They can host a wide variety of data, from website assets to big data for analytics, and provide APIs for searching and accessing the stored data.

During operation, the compact search client 128 receives a verbal initial search query from the user 108. The augmented search engine 104 receives the query and initiates an augmented search process. During the augmented search process, the augmented search engine 104 determines a search phase of the search process and guides the search according to the determination. In a case that the augmented search engine 104 determines that additional user input is useful, the augmented search engine 104 prompts the user 108 using the compact search client 128 to provide additional user input based on the search query as described herein. The augmented search engine 104 generates one or more search queries that are used to query an internal index search engine hosted by the augmented search engine 104 and/or query the one or more external search engines 106 as described herein. The augmented search engine 104 receives search results from the internal index search engine or the one or more external search engines 106 and uses either an internal search summary generative model or an external general purpose external generative model of the one or more external generative models 110 to generate a search summary of the search results. The augmented search engine 104 provides the search summary as a verbal search summary to the user 108 using the compact search client 128 via the WAN 102.

In some examples, the user 108 uses a mobile device 140 such as, but not limited to, a smartphone or the like, to configure the compact search client 128. For example, the user 108 links the compact search client 128 to the mobile device 140 over a wired or wireless connection such as, but not limited to, Bluetooth or the like. Configuration information may include, but is not limited to:

WiFi Network Name and Password: In some examples, the user 108 inputs the SSID (Service Set Identifier) and password of their preferred WiFi network to enable the compact search client 128 to connect to the augmented search engine 104.

Bluetooth Pairing Information: In some examples, if the compact search client 128 uses Bluetooth for connectivity, pairing information such as device names and pairing codes may be configured to establish a secure connection with the mobile device 140 or other peripherals.

Language Settings: In some examples, the user 108 can select their preferred language for the interface and voice interactions, ensuring that the device communicates in a language that they understand.

Volume Levels: In some examples, the user can adjust the audio output levels of the compact search client 128, setting the default volume for alerts and responses.

Sleep/Wake Timers: In some examples, configuration of the compact search client 128 includes setting timers for when the device should automatically go into a low-power sleep mode and when it should wake up.

Interaction Modes: In some examples, the user may configure how the device responds to inputs, such as whether it provides tactile feedback, visual signals via LEDs, or auditory cues.

Access Controls: In some examples, the user 108 sets up PINs or passwords to restrict access to the functionalities of the compact search client 128.

Data Encryption Options: In some examples, the user 108 configures the compact search client 128 to encrypt stored data and communications to protect user privacy.

Firmware Update Preferences: In some examples, the user 108 can configure how and when the compact search client 128 checks for and installs firmware updates, possibly scheduling updates for times when the compact search client 128 is not in active use.

Diagnostics and Performance Monitoring: In some examples, the user can enable or disable diagnostic data collection that helps in maintaining the operation of the compact search client 128 and troubleshooting issues.

App Permissions: In some examples, if the compact search client 128 interacts with specific applications, the user may need to configure permissions for what data these apps can access and what functions they can perform.

Custom Commands: In some examples, the user 108 may define specific voice commands or button presses to perform custom actions tailored to the user's needs.

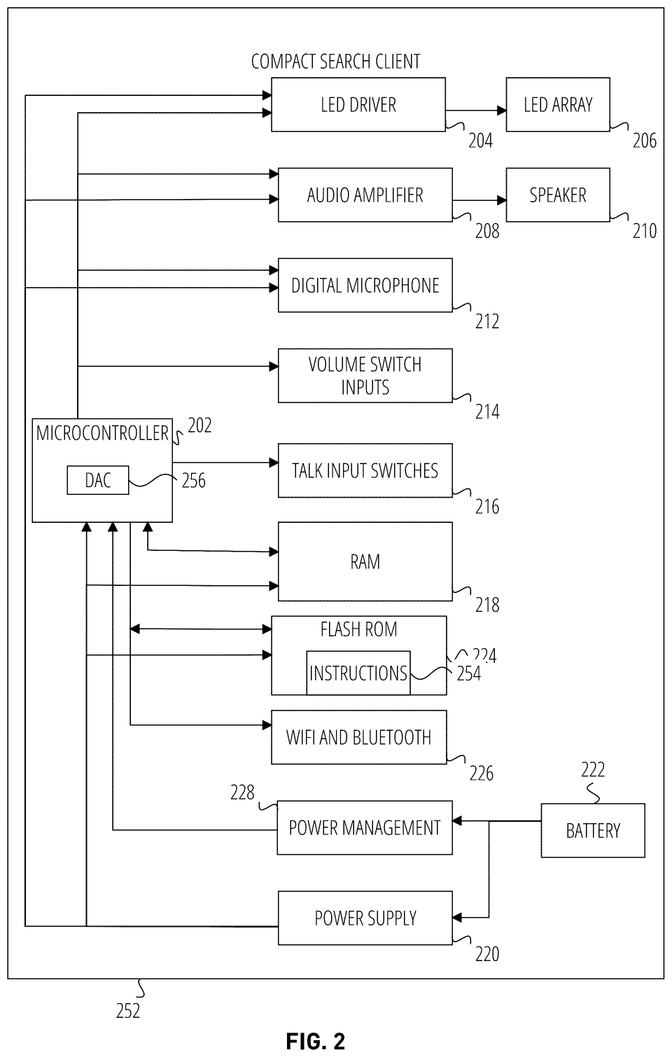

FIG. 2 is an architecture of a compact search client 252, according to some examples. A compact search client 252 includes a microcontroller 202, an LED driver 204, an LED array 206, an audio amplifier 208, a speaker 210, a digital microphone 212, a volume switch inputs 214, a talk input switches 216, Random Access Memory (RAM) 218, a power supply 220, a battery 222, flash Read Only Memory (ROM) 224, a WiFi and Bluetooth component 226, and a power management component 228.

In some examples the microcontroller 202 is an integrated circuit designed to perform specific operations of the compact search client 252. The microcontroller 202 includes one or more built-in processors along with memory and programmable input/output peripherals. The one or more processors handle tasks such as arithmetic operations, data management, and control signal generation. The microcontroller 202 executes dedicated instructions 254 to implement the methodologies of the compact search client 252 as described herein.

In some examples, the microcontroller 202 comprises a basic MicroController Unit (MCU) that is suitable for handling simple computational tasks within an embedded system. In some examples, the microcontroller 202 comprises an advanced microcontroller with integrated features such as USB connectivity, analog-to-digital converters, and on-chip memory. In some examples, the microcontroller 202 comprises a system on a chip (SoC) microcontroller that integrates not only the core processing unit but also signal processing capabilities, network modules, and the like.

In some examples, the functions of the microcontroller 202 are performed by other types of data processing machines such as, but not limited to, a microprocessor, a Field Programmable Gate Array (FPGA), and the like.

In some examples, the microcontroller 202 is operatively connected to an LED driver 204. The LED driver 204 controls the power supplied to an LED array 206, ensuring that the LEDs operate safely and efficiently. It adjusts the brightness and can control the color output of the LEDs, which are often used for status indicators or user interface elements on the compact search client 252. The LED array 206 includes multiple light-emitting diodes that provide visual feedback to the user. The LED array 206 can display various signals such as power status, connectivity status, or other operational states of the compact search client 252 through different colors or blinking patterns.

In some examples, the microcontroller 202 is operatively connected to an audio amplifier 208. The audio amplifier 208 increases the amplitude of audio signals received from the microcontroller 202, making them powerful enough to drive a speaker 210 effectively. This component ensures that the output sound is audible and clear, enhancing the user's audio experience. The speaker 210 converts audio signals of verbal prompts and verbal search summaries into sound waves that the user can hear.

In some examples, the microcontroller 202 includes a Digital to Analog Converter (DAC) 256 used to convert digital audio signals into analog audio signals that can be amplified by the audio amplifier 208 and played through the speaker 210.

In some examples, the microcontroller 202 is operatively connected to a digital microphone 212. The digital microphone 212 captures sound waves representing verbal queries (in one or more languages) and verbal responses made by a user and converts them into digital audio signals of audio queries and audio responses for processing by the microcontroller 202.

In some examples, the microcontroller 202 is operatively connected to volume switch inputs 214. These inputs allow the user to manually adjust the volume of the output sound from the compact search client 252. They provide a simple interface for increasing or decreasing the sound level according to the user's preference.

In some examples, the microcontroller 202 is operatively connected to one or more talk input switches 216. These switches enable a user to initiate voice commands or communications. By pressing these switches, a user can activate a compact search client 252 listening mode, readying the compact search client 252 to receive and process verbal queries and verbal responses from the user.

In some examples, the microcontroller 202 is operatively connected to a RAM 218. The RAM (Random Access Memory) provides temporary data storage for the microcontroller 202 to access program instructions 254 and operational data quickly.

In some examples, the microcontroller 202 is operatively connected to a power supply 220. The power supply regulates the distribution of electrical power to all components of the compact search client 252. The power supply 220 converts incoming electricity from the battery 222 or external sources into the voltages used by the various components of the compact search client 252.

In some examples, the microcontroller 202 is operatively connected to a battery 222. The battery provides portable power to the compact search client 252, enabling the compact search client 252 to operate without being tethered to a stationary power source.

In some examples, the microcontroller 202 is operatively connected to a flash Read-Only Memory (ROM) 224. The flash ROM 224 stores firmware instructions 254 and other permanent data needed for the operation of the compact search client 252. This non-volatile memory retains its data even when the compact search client 252 is powered off, ensuring that essential software is available immediately upon startup. The instructions 254 (e.g., software, a program, an application, an applet, an application, or other executable code) for causing the compact search client 252 to perform any one or more of the methodologies discussed herein may be executed. For example, the instructions 254 may cause the compact search client 252 to execute any one or more operations of any one or more of the methods described herein. In this way, the instructions 254 transform a general, non-programmed microcontroller 202 into a particular machine (e.g. a host for a client) that is specially configured to carry out any one of the described and illustrated functions in the manner described herein.

In some examples, the microcontroller 202 is operatively connected to a WiFi and Bluetooth component 226. This component enables wireless connectivity to other devices and networks via WiFi and Bluetooth protocols. It allows the compact search client 252 to communicate with an augmented search engine over the Internet and other compatible devices, facilitating data exchange and remote operations.

In some examples, the microcontroller 202 is operatively connected to a power management component 228. This component oversees the power usage of the compact search client 252, optimizing battery life and ensuring energy efficiency. It manages the distribution of power to various components and controls power-saving features based on the device's operational status.

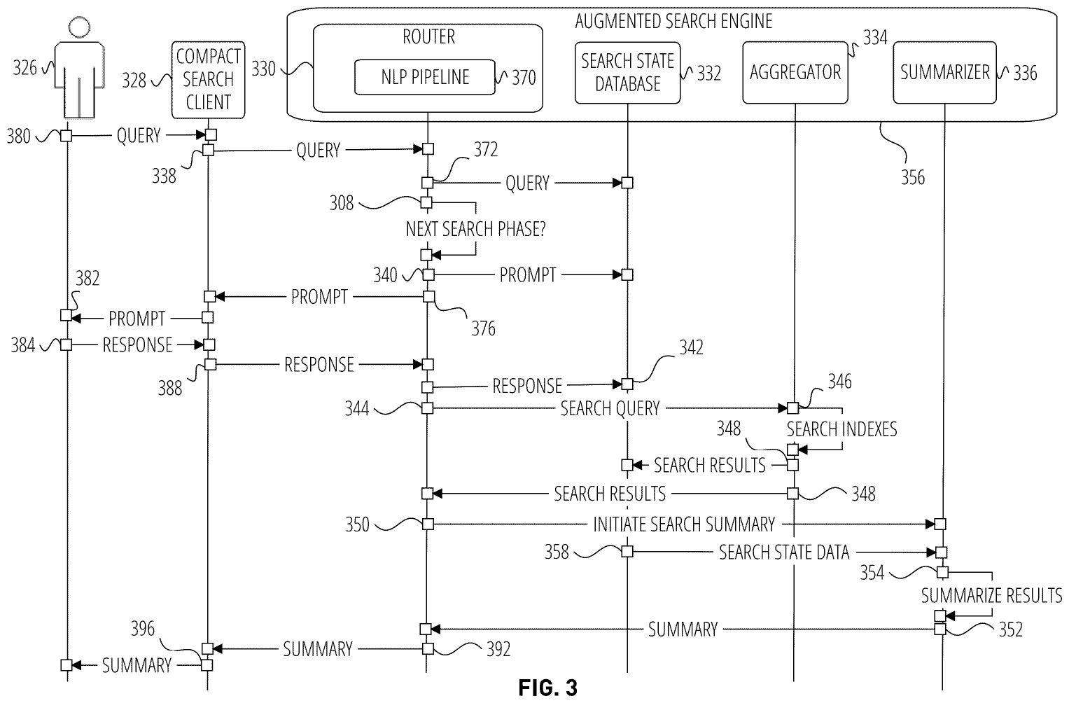

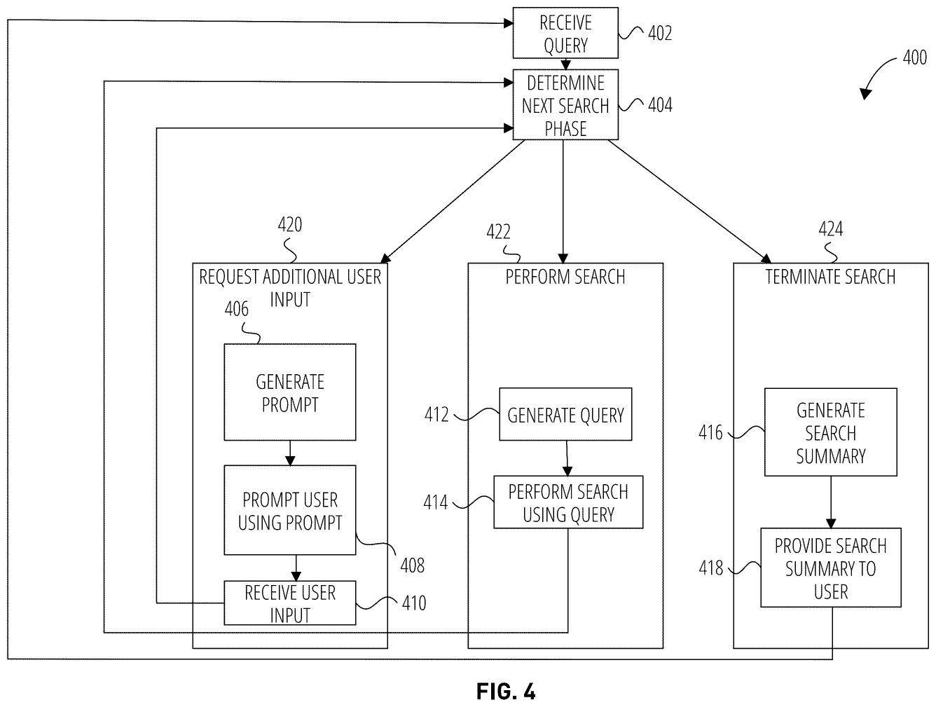

FIG. 4 is a process flow diagram and FIG. 3 is a sequence diagram of a use of a compact search client 328 to perform an augmented search, according to some examples. An augmented search engine 356 receives verbal queries 380 and verbal responses 384 from a user 326 via the compact search client 328. The augmented search engine 356 also provides verbal search summaries 396 to the user via the compact search client 328 at the completion of the search. Although the example augmented search method 400 depicts a particular sequence of operations, the sequence may be altered without departing from the scope of the present disclosure. For example, some of the operations depicted may be performed in parallel or in a different sequence that does not materially affect the function of the augmented search method 400. In other examples, different components of an augmented search engine that implements the augmented search method 400 may perform functions at substantially the same time or in a specific sequence.

In operation 402, the augmented search engine 356 receives a query 372 from a user 326. For example, the compact search client 328 receives a verbal query 380 from the user 326. The compact search client 328 generates an audio query 338 comprising a digital audio signal of the verbal query 380 using a digital microphone 212 (of FIG. 2). The compact search client 328 uses a WiFi and Bluetooth component 226 (of FIG. 2) to communicate the audio query 338 (as data) to a router 330 of the augmented search engine 356 over a communications network such as the Internet or the like. The router 330 receives the audio query 338 and uses an NLP pipeline 370 to generate a query 372 using the digital audio signal of the audio query 338 and speech recognition methodologies.

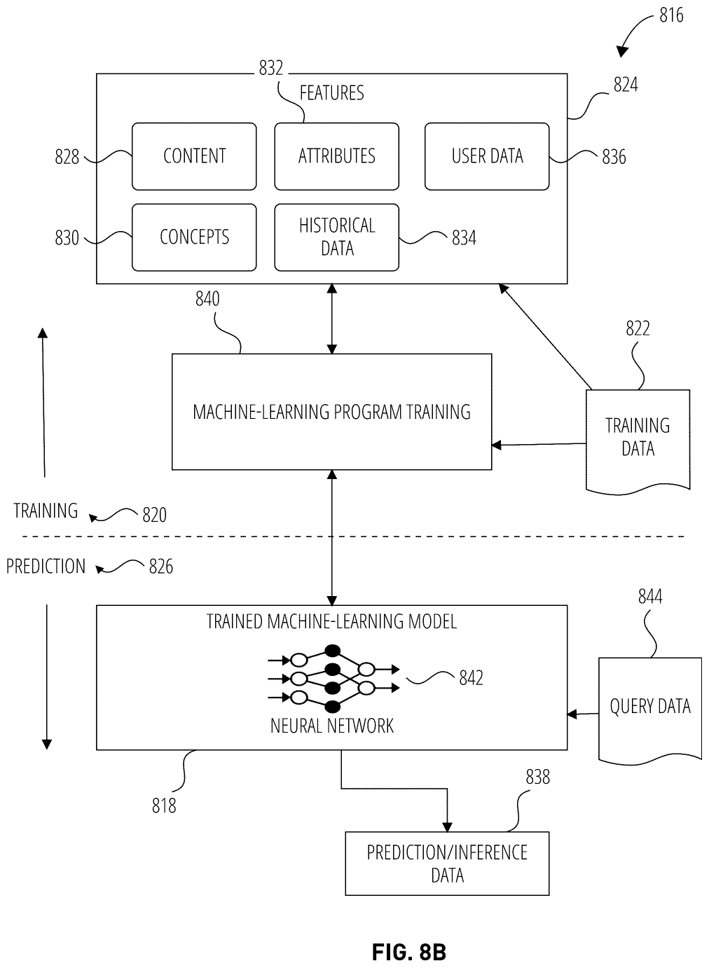

In some examples, the NLP pipeline 370 uses one or more speech-to-text machine learning models to generate the data of the query 372 from the audio query 338. The speech-to-text machine learning models are trained to recognize speech from audio signals as more fully described in reference to FIG. 8A and FIG. 8B. Training data used to train the speech-to-text machine learning models includes, but is not limited to:

Audio Data: This is the primary type of data used for training the speech-to-text models. The audio data includes recordings of human speech in various languages, accents, dialects, and speaking styles.

Transcription Data: Alongside the audio recordings, transcription data is used to train the speech-to-text machine learning models. These are accurate textual representations of the spoken words in the audio files. The transcriptions are used as labels during the training process to teach the speech-to-text machine learning models what text corresponds to given segments of audio.

Noise and Environment Variability: To ensure the speech-to-text machine learning models perform well in real-world scenarios, the speech-to-text machine learning models are trained with audio data that includes background noises and sounds from different environments, such as offices, outdoor spaces, and crowded areas.

Retraining Data: In some examples, the speech-to-text machine learning models are periodically retrained or fine-tuned with audio data of verbal queries and verbal responses made by users of a system having a compact search client and an augmented search engine. The data of verbal queries and verbal responses is transcribed and used to retrain the speech-to-text machine learning models to adapt the speech-to-text machine learning models to new vocabulary, accents, or changes in language usage over time. This helps in maintaining the accuracy and relevance of the speech-to-text machine learning models.

The NLP pipeline 370 communicates the query 372 (as data) to a router 330 of the augmented search engine 356. The router 330 receives the query 372. In some examples, the router 330 stores the query 372 in a search state database 332. The search state database 332 stores a search state data of an augmented search and is used by components of the augmented search engine 356 to determine a state of the augmented search method 400.

In some examples, in addition to the audio query 338, the search state data may include various types of information (stored as data) to enhance the search process and user experience including, but not limited to:

User responses to prompts: Records of user responses to one or more prompts, which can be used to refine search queries 344 or determine the next steps in a search process.

Search results: Information about search results 348 obtained from querying search indexes, which can be used for generating search summaries or for further refinement of search queries 344.

Search queries: The evolution of a search query from the query 372 through various refinements based on user input and system-generated prompts.

User session data: Data capturing the sequence of actions taken by the user 326 during a session, which can help in understanding user behavior and preferences. This is one type of metadata that may be utilized in certain embodiments.

Intermediate search phases: Snapshots of the search phase at various points, which can be used to backtrack or understand the decision-making process of the system.

Search preferences: User-specified preferences or settings that influence search behavior, such as filters, search domains, or language preferences.

Query classification data: Information related to the classification of queries into categories or intents, which can guide the generation of prompts or the selection of search strategies.

Search metrics: Performance metrics or analytics data related to the search process, such as response times, accuracy of results, or user satisfaction indicators. This is a second type of metadata utilized by certain embodiments.

Error logs: Records of any errors or issues encountered during the search process, which can be useful for debugging or improving the system. These records may be stored in an error log file, which may be a text file or executable file for providing information about errors or issues encountered during the search process. Such error logs may comprise error log metadata for each record, such as time of error, the process executing at the time of the error, the process that failed as a result of (or causing) the error, and/or the like.

Feedback data: User feedback on the search results or the overall search experience, which can be used for continuous improvement of the system.

In operation 404, the router 330 determines a search phase of the augmented search method 400. In some examples, a search phase is a request additional user input phase 420 where the augmented search method 400 requests additional information from the user 326 using one or more prompts 340. In some examples, a search phase is a perform search phase 422 in which the augmented search method 400 performs an augmented search using one or more search engines. In some examples, a search phase is a terminate search phase 424 in which the augmented search method 400 generates a search summary that is presented to the user 326.

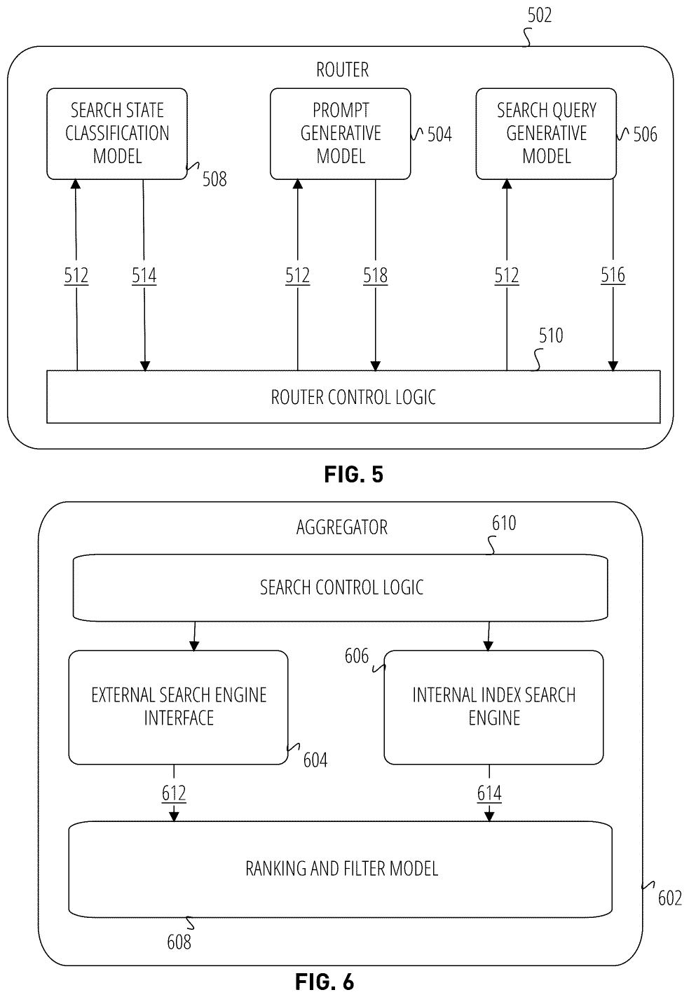

For example, in reference to FIG. 5, a router 502 includes a search state classification model 508 that analyzes search state data 512 including a query to determine if the query contains sufficient amounts of information for the augmented search engine 356 to perform an effective search. The search state classification model 508 operates by applying predefined criteria to the search state data 512 including the query, assessing the specificity and relevance of the query as expressed in a next search phase 514 determination. Based on the next search phase 514, the router 502 can then decide on the next search phase such as, but not limited to proceeding directly to a perform search phase or requesting additional user input from the user in a request additional user input phase. This process provides for optimizing the search operation by determining that the augmented search engine has sufficient information to retrieve relevant results from a search.

In some examples, the search state classification model 508 is part of a processing pipeline that extracts features from the query. These features encompass various aspects such as a length of the query, a presence of specific keywords or phrases, a use of question formats, and other linguistic or semantic properties indicative of the completeness and specificity of the query.

In some examples, the router 502 performs an initial search using a query to determine a set of intermediate search results. These intermediate search results are stored in the search state database 332 (of FIG. 3) as part of the search state data 512 and provided to the search state classification model 508 including the query to determine if the query provides sufficient information to provide adequate results from a search.

In some examples, as more fully described in reference to FIG. 8A and FIG. 8B, the search state classification model 508 is trained to a dataset of queries. The queries in the dataset of queries (forming all or part of training data) are annotated according to their adequacy in generating useful search results, allowing the search state classification model 508 to discern patterns and correlations between the features of the queries and their effectiveness. To make predictions about new, unseen queries, the search state classification model 508 employs a classification algorithm. This could be logistic regression, decision trees, neural networks, or any other suitable algorithm that can handle the complexity of the feature space and the nuances of the training data. Training data used to train the search state classification model 508 to determine whether a query contains enough information to perform an augmented search includes, but is not limited to:

Queries: A diverse collection of queries submitted by users, covering various topics, domains, and levels of specificity. These queries should range from very detailed and specific to vague and ambiguous, to provide the model with examples across the spectrum of query completeness.

User interactions: Data capturing the interactions between the augmented search engine and users following the submission of queries. This includes any clarifying questions posed by the search engine and the corresponding user responses. These interactions are useful for teaching the model how additional information can transform an incomplete query into one that is ready for a search.

Query annotations: Queries and subsequent user interactions are annotated to indicate whether the query, at each stage of interaction, contains enough information to perform a search. These annotations serve as the ground truth for training the model.

Search outcomes: Information about the success of searches conducted based on the queries and user interactions including metrics such as relevance scores of search results, user satisfaction ratings, or click-through rates, which help to validate the completeness and effectiveness of the queries.

Contextual information: Additional data that provides context to the queries and user interactions, such as the time of day the query was made, the user's search history, and any preferences or constraints specified by the user. This information can be useful for understanding the circumstances under which a query is considered complete.

Extracted features: The training data is processed using NLP techniques to extract meaningful features from the textual data. This includes, but is not limited to, tokenization, part-of-speech tagging, named entity recognition, and sentiment analysis, among others, to capture the semantic and syntactic characteristics of the queries and interactions.

Balanced examples: The training dataset includes, but is not limited to, a balanced mix of examples where queries are deemed complete and ready for a search and examples where queries require additional information. This balance is necessary to prevent model bias towards one outcome over the other.

In some examples, the search state classification model 508 is continuously trained using a feedback loop. This mechanism enables continuous improvement of the classifications of the search state classification model 508 by using the outcomes of predictions to refine training data of the search state classification model 508 and retrain the search state classification model 508. Such a loop allows the search state classification model 508 to adapt to new patterns in query behavior and changes over time, enhancing accuracy and reliability of the search state classification model 508.

In some examples, using a search state classification model 508 to determine if a query contains enough information to perform an augmented search provides several features that enhance both the efficiency and effectiveness of the search process. One of the features is improved search efficiency. By accurately identifying whether a query contains sufficient information, the search state classification model 508 helps streamline the search process. This prevents an augmented search engine from initiating searches based on incomplete or ambiguous queries that are unlikely to yield useful results, thereby reducing unnecessary computational load and improving response times for users.

In some examples, another feature is the enhancement of the user experience. The search state classification model 508 contributes to a more interactive and responsive search experience by triggering the augmented search engine to request specific clarifications from the user when additional information is needed. This interaction ensures that users are guided towards refining their queries in a manner that directly addresses their information requirements, leading to more satisfactory search outcomes.

In some examples, the use of the search state classification model 508 increases the relevance of search results. By ensuring that searches are conducted only when queries are sufficiently detailed, the likelihood of retrieving relevant and accurate search results is increased. This relevance is useful for user satisfaction and can significantly enhance the perceived value and effectiveness of an augmented search engine.

In some examples, the search state classification model 508 also adapts to user intent, allowing the augmented search engine to better understand what the user is actually seeking, even if their query was not explicitly clear. This adaptability is based on the ability of the search state classification model 508 to assess query completeness by analyzing the query and any subsequent user interactions.

In some examples, as the search state classification model 508 processes more queries and user interactions, the search state classification model 508 continuously learns and improves its ability to assess query completeness. This ongoing learning process enables the search state classification model 508 to adapt to changes in user behavior, query patterns, and information requirements, ensuring that the augmented search engine remains effective and responsive over time.

In some examples, the operation of the search state classification model 508 generates data on common patterns of query incompleteness and user interaction. Analyzing this data can provide insights into how users formulate queries and what types of information tend to be missing. These insights can inform further improvements to the user interface of the augmented search engine and query processing algorithms.

In some examples, the automated nature of the search state classification model 508 allows the augmented search engine to handle large volumes of queries efficiently. By automating the assessment of query completeness, the search state classification model 508 enables the augmented search engine to scale its operations to accommodate growing numbers of users and queries without compromising on the quality of the search experience. Collectively, these features contribute to more efficient search processes, improved user experiences, and the ongoing improvement and scalability of the augmented search engine.

In some examples, as a search process unfolds, the augmented search engine 356 generates one or more optimized search queries based on the original query 372 and any additional responses 342 to prompts 340. These optimized search queries, designed to retrieve relevant search results, are stored as part of the search state data in the search state database 332. The storage of these search queries 344 allows for a detailed understanding of how queries are transformed and optimized over the course of a search session.

Referring to FIG. 3 and FIG. 4, in response to determining that the augmented search method 400 is in a request additional user input phase 420 because the query 372 is inadequate to generate relevant search results, the router 330 determines to request additional user input in the form of one or more responses 342 (e.g., vocal responses captured as audio data by a microphone, or other responses, such as input provided via a touch screen or keypad) to one or more prompts 340 (e.g., generated as audio output via a speaker or generated as visual output on a screen of a device) in order to overcome the deficiencies of the query.

In operation 406 of the request additional user input phase 420, the router 330 generates a prompt 340 for the user 326 using the query 372. For example, in reference to FIG. 5, a router 502 uses a prompt generative model 504 (e.g., a Large Language Model (LLM) or the like) to generate a prompt 518 based on the search state data 512 including a query. In some examples, the prompt generative model 504 is trained on datasets of search state data 512 including queries and corresponding prompts that were found to effectively elicit more detailed or specific information from users as more fully described in reference to FIG. 8A and FIG. 8B. This training enables the prompt generative model 504 to understand the nuances of human language and the common patterns or gaps in queries that might require further clarification. Training data for training the prompt generative model 504 includes, but is not limited to:

User queries and responses: A collection of user queries followed by the responses or additional information provided by users when prompted. This dataset covers a wide range of topics and query complexities to teach the prompt generative model 504 about different types of information that might be missing from queries.

Prompt and response pairs: Examples of effective prompts that have previously led to users providing useful additional information, paired with the user responses to these prompts. Analyzing these pairs helps the prompt generative model 504 learn how to formulate prompts that are likely to elicit detailed and relevant information from users.

Annotated queries: Queries annotated with information about what specific details are missing or what aspects of the query need clarification. These annotations serve as a guide for the prompt generative model 504 to understand the common patterns of incomplete information in user queries.

Contextual information: Data providing context to the queries, such as the user's search history, the time of the query, and any preferences or constraints specified by the user. This information is used for generating personalized prompts that are relevant to the user's current search context.

User interaction data: Data capturing the entire interaction flow between the user and the augmented search engine, including the prompts presented to the user and their subsequent responses. This view of the interaction helps the model understand the progression of a search session and how different prompts contribute to refining the search.

Feedback on prompt effectiveness: User feedback or engagement metrics related to the effectiveness of different prompts, such as the rate of user response to prompts, the relevance of the information provided by users, and user satisfaction with the search outcomes following the prompts. This feedback helps in evaluating and improving the quality of the prompts generated by the prompt generative model 504.

In some examples, the training data is enriched with NLP features extracted from the queries and responses, such as named entity recognition, part-of-speech tagging, and sentiment analysis. These features help the prompt generative model 504 grasp the linguistic structure and semantic content of the queries and responses.

When the router 502 passes the search state data 512 including the query to the prompt generative model 504 using the router control logic 510, the prompt generative model 504 analyzes the query using the patterns the prompt generative model 504 has learned and generates a prompt 518.

In some examples, an analysis involves breaking down the query into its constituent features, such as the topics mentioned, the specificity of the language used, and any keywords that might indicate what the user is looking for. Based on this analysis, the prompt generative model 504 generates a prompt 518 that is tailored to the query. The prompt 518 is designed to be clear and direct, asking the user for specific information to refine the search. For example, if the query is vague or broad, the generated prompt 518 might ask the user to specify a particular aspect of their query or to provide additional keywords.

In some examples, the prompt 518 takes the form of one or more questions that are asked of the user. For example, if an initial analysis of the query determines that are multiple interpretations of a term and the correct interpretation of the term is not discernible from the query, the prompt 518 may take the form of a question that disambiguates the term.

In some examples, the router 502 performs an initial search using the query to obtain intermediate search results that are used along with the query to generate the prompt 518.

In some examples, the router 502 provides the prompt generative model 504 with a search state data 512. The search state data 512 is used as a context by the prompt generative model 504 when generating the prompt 518.

In some examples, a prompt generative model is external to an augmented search engine such as, but not limited to, a general purpose LLM hosted by a third party. In such an arrangement, the router 502 uses router control logic 510 to compose a generation prompt for generated a prompt using the search state data 512 including the query. The generation prompt is communicated to the external prompt generative model, and the prompt 518 is received from the external prompt generative model using an Application Programming Interface (API) of the external prompt generative model. In some examples, the prompt sent to the external prompt generative model is generated using the query and the search state data 512.

Utilizing a prompt generative model 504 for generating prompts 518 in an augmented search offers a multitude of technical features that enhance the search experience. In some examples, a benefit is personalization, where the prompt 518 can use the search state data 512 including user data including a search history to tailor prompts to a user's specific query context and preferences, thereby boosting user engagement and satisfaction by providing a more intuitive search interface. This approach also brings about greater efficiency by automating the generation of prompts using a generative LLM, allowing the router 502 to swiftly respond to user queries without manual intervention and reducing the time between a user's query and an augmented search engine requests for additional information. Without this automated generation of prompts, a user would be required to input substantially more precise prompts to ensure a useful output is generated by a search interface.

In some examples, the prompt generative model 504 is adaptable, enabling the prompt generative model 504 to adjust to new types of queries or shifts in user behavior over time. This ensures the augmented search engine remains effective and relevant. The incorporation of NLP techniques enhances the contextual understanding of the prompt generative model 504, enabling the prompt generative model 504 to grasp the intent behind a user's query more accurately and generate more relevant prompts 518. This capability, which is executed by a computing system, improves the likelihood of the search interface retrieving accurate and useful search results because the search interface receives more accurate input data.

In some examples, errors are reduced during prompt 518 generation, which might occur with manual or rule-based systems. By leveraging the prompt generative model 504 trained on extensive data, the augmented search engine minimizes errors when generating output of the search, thereby maintaining user trust in the capabilities of the augmented search engine.

In some examples, use of the prompt generative model 504 promotes scalability of the search system by handling a large volume of queries across different domains without the need for domain-specific adjustments, facilitating system expansion and accommodation of a growing user base. In some examples, the prompt generative model 504 is capable of generating prompts relevant to a vast range of topics, based at least in part on a user's initial prompt provided as user input and by leveraging a model that is trained with training data relevant to the vast range of topics.

In some examples, the use of the prompt generative model 504 for prompt 518 creation fosters a more interactive search experience. By engaging users in a dialogue, the augmented search engine can refine its understanding of the user's requirements, leading to more accurate and satisfying search outcomes.

Referring to FIG. 3 and FIG. 4, in the request additional user input phase 420, in operation 408, the augmented search engine 356 prompts the user 326 inviting the user 326 to respond to the prompt 340 with more detailed information in the form of a response 342. For example, the router 330 communicates the prompt 340 to the NLP pipeline 370. The NLP pipeline 370 receives the prompt 340 and generates data of an audio prompt 376 comprised of a digital audio signal of the prompt 340 using NLP methodologies. In some examples, the NLP pipeline 370 uses one or more text-to-speech machine learning models trained to generate digital audio speech data from text. The training of the text-to-speech machine learning models is more fully described in reference to FIG. 8A and FIG. 8B. The training data used to train a text-to-speech machine learning model may include, but is not limited to:

Text Data: This includes a large corpus of written text that covers a wide range of topics, styles, and vocabulary.

Phonetic and Prosodic Annotations: Alongside the raw text, phonetic transcriptions that indicate how words are pronounced and prosodic information that conveys speech melody and intonation are essential. These annotations help the text-to-speech machine learning model learn how to pronounce words correctly and with natural intonation.

Voice Recordings: High-quality recordings of human speech are used to train the text-to-speech machine learning model on how to generate speech that sounds human-like. These recordings are typically done by professional voice actors and cover various emotions and intonations.

Retraining Data: To adapt to changes in language use and to improve the naturalness of the synthesized speech, the text-to-speech machine learning model may use additional data collected during operation of a system including a compact search client and an augmented search engine after the initial training phase. This retraining data helps refine the model's performance and adapt to new linguistic trends or user feedback.

In some examples, the router 330 stores the prompt 340 in the search state database 332 as part of search state data of a search process for further use by the components of the augmented search engine 356.

The augmented search engine 356 communicates the audio prompt 376 to the compact search client 328. The compact search client 328 receives the audio prompt 376 and generates a verbal prompt 382 and provides the verbal prompt 382 (output as audio from a speaker 210) to the user 326. For example, the compact search client 328 receives the audio prompt 376 and converts the digital audio signal of the audio prompt 376 into the verbal prompt 382 comprising an audio signal provided to the user 326 using a DAC 256 (of FIG. 2) of a microcontroller 202 (of FIG. 2), an audio amplifier 208 (of FIG. 2) and a speaker 210 (of FIG. 2).

In operation 410, the router 330 receives a response 342 from the user 326 in response to the user prompt 340. For example, the compact search client 328 receives, from the user 326, a verbal response 384 in response to the verbal prompt 382 (specifically, audio is captured and stored as data). The compact search client 328 uses a digital microphone 212 (of FIG. 2) to generate an audio response 388 comprised of a digital audio signal of the verbal response 384. The compact search client 328 uses a WiFi and Bluetooth component 226 (of FIG. 2) to communicate the audio response 388 to the router 330 over a communications network such as the Internet or the like. The router 330 receives the digital audio signal of the audio response 388 and uses the NLP pipeline 370 to generate a response 342 using the digital audio signal of the audio response 388 and speech recognition methodologies.

In some examples, the router 330 stores the response 342 as part of the search state data in the search state database 332.

After processing the response 342, the router 330 transitions to operation 404. In operation 404, the router 330 determines a next search phase 308 of the augmented search method 400. For example, in reference to FIG. 5, the search state classification model 508 determines that the router 502 has enough information to begin an augmented search. The search state classification model 508 is trained using a training dataset that includes sets of search state data that indicate that the router 502 has enough information to perform a search as more fully described in reference to FIG. 8A and FIG. 8B. Example training data for training the search state classification model 508 to recognize that an augmented search process is prepared to enter a search performance phase includes, but is not limited to:
Initial queries: A collection of queries that vary in specificity and clarity. This would include queries that are well-defined and contain sufficient detail for a search to be conducted without additional user input.
User prompts and user inputs: For queries that initially lacked clarity or specificity, the dataset should include the prompts generated by a system to request more information and the corresponding user responses. Instances where the user responses effectively clarify or complete the query information would be labeled as ready for search.
Search queries: The final search queries derived from the queries and any subsequent user interactions. These search queries should represent a state where the query is deemed complete and actionable for performing a search.
Contextual information: Additional data points that provide context to the queries, such as the time of the query, the user's search history, and any preferences or settings that might influence the readiness of the search phase.
Intermediate search results: Instances that capture the state of the search at various checkpoints, including any intermediate search results, the evolution of the search query, and changes in search parameters. These instances help the model learn the progression towards a search-ready state.

In some examples, employing the search state classification model 508 to ascertain whether a search is in a state ready to be performed in a search phase offers features that enhance the efficiency and effectiveness of an augmented search engine. A feature is the ability to automate the decision-making process regarding the readiness of a search. This automation reduces the need for manual intervention, streamlining the search process and enabling the augmented search engine to handle a larger volume of queries more swiftly. By accurately identifying when enough information has been gathered to proceed with a search, the search state classification model 508 ensures that searches are initiated at the optimal time, thereby improving the user experience by delivering timely and relevant search results.

In some examples, another feature is the improvement in search result relevance. The capability of the search state classification model 508 to discern whether the collected information is sufficient for a search allows for the initiation of searches only when the augmented search engine has a clear understanding of the intent of the user. This clarity in understanding the intent of the user leads to more accurate and targeted search results, as the augmented search engine can effectively utilize the available information to refine the search parameters. Consequently, users receive search results that are more closely aligned with their information requirements, enhancing their satisfaction with the augmented search engine.

In some examples, the use of a search state classification model 508 (which may be a separately trained model operating in an ensemble configuration with the augmented search engine, or may be an integrated characteristic of the augmented search engine) contributes to a more dynamic and responsive augmented search engine. By continuously evaluating the search phase based on user inputs and interactions, the search state classification model 508 adapts output of the augmented search engine to the user's evolving information requirements in real-time. If the search state classification model 508 determines that additional information would be useful, an augmented search engine prompts the user for further clarification, ensuring that the search process is guided by the current and comprehensive understanding of the user's query. This adaptability improves the accuracy of search results and fosters a more engaging and interactive search experience for the user.

In some examples, the implementation of a search state classification model 508 enhances the augmented search engine's scalability. As the volume of queries and the diversity of user information requirements grow, the search state classification model 508 ensures that the augmented search engine can efficiently manage and respond to these queries without compromising on the quality of search results. The ability of the search state classification model 508 to automate the assessment of search readiness allows the augmented search engine to scale its operations, accommodating an increasing number of users and queries while maintaining high standards of performance and user satisfaction.

Because the search state classification model 508 performs such assessments automatically, the augmented search engine executes searches based on the search readiness, thereby minimizing search tasks for queries that are characterized by the search state classification model 508 as having a low search readiness (e.g., which may be indicated with a score). This scalability provides for the long-term success and reliability of the augmented search engine, ensuring it can meet the demands of its users effectively.

Referring to FIG. 3 and FIG. 4, in response to determining that the augmented search method 400 is ready to enter a perform search phase 422, the router 330 transitions to operation 412.

In operation 412, the router 330 generates a search query 344. For example, in reference to FIG. 5, a router 502 uses a search query generative model 506 to generate one or more search queries 516. Inputs into the search query generative model 506 vary depending on the path that lead to an augmented search engine being an a search phase of being ready to perform a search. In some examples, a query may have been sufficient to generate the one or more search queries 516 and the search query generative model 506 uses the query to generate the one or more search queries 516. In some examples, the augmented search engine may have received user input along with the query and the search query generative model 506 generates the one or more search queries 516 using the query and the user input. In some examples, search state data 512 of an augmented search is supplied as context to the search query generative model 506.

The inputs into the search query generative model 506 (e.g., text as entered by the user or text generated by a speech-to-text model) encapsulate the intent of the user and may vary in complexity from simple keyword-based queries to more complex natural language questions or statements.

In some examples, the router control logic 510 preprocesses the inputs to the search query generative model 506 to clean and normalize the input data. Tasks during preprocessing may include lowercasing text, removing punctuation, correcting misspellings, and tokenizing initial queries and user inputs into individual words or phrases, aiming to standardize the input for better analysis by the search query generative model 506. Such normalization may be performed using grammatical models built with a plurality of rules, and which may be executed upon receipt of text.

In some examples, following preprocessing, the router control logic 510 extracts relevant features from the inputs to the search query generative model 506. These features may include both semantic and syntactic elements used to understand the user's intent. In some examples, to enrich the feature set, advanced Natural Language Processing (NLP) techniques such as part-of-speech tagging, named entity recognition, and dependency parsing are employed.

In some examples, the search query generative model 506 is trained during a training phase as more fully described in reference to FIG. 8A and FIG. 8B. Training data used to train the search query generative model 506 includes, but is not limited to:
Queries and search intent: This data consists of queries, which are textual representations of users' information requests. These queries can range from simple, keyword-based queries to complex, natural language questions. A query is associated with the intended search intent, which defines what the user is looking for. This intent can be explicit or implicit within the query text.
Optimized search queries: For a query, the training data includes one or more optimized search queries. These are the queries that have been refined or reformulated to better match the search intent with the content available in search indexes. Optimized search queries are designed to improve the relevance and precision of search results.
Search results and relevance feedback: In addition to the queries themselves, the training data may also include information about the search results generated by the optimized search queries and user interactions with these results. This can include click-through data, dwell time on search results, and explicit relevance feedback provided by users. Such data helps the model learn which query formulations are effective in leading to satisfactory search outcomes.
Contextual information such as search state data: The training data can also incorporate contextual information that influences the formulation of search queries. This includes the user's geographical location, the time of the query, the device used for the search, and any session information that provides context to the user's search behavior. Contextual information helps the model understand variations in query formulation based on external factors.
Semantic annotations: To enhance the model's understanding of natural language queries, the training data may be enriched with semantic annotations. These annotations can include named entity recognition, part-of-speech tagging, and semantic roles of words or phrases within the queries. Semantic annotations aid the model in grasping the linguistic structure and meaning of the queries.
Synthetic queries: In addition to real queries, the training data may include synthetic queries generated through data augmentation techniques. These synthetic queries can help increase the diversity of the training data, especially in covering rare or underrepresented query types.

In some examples, a search query generative model is external to an augmented search engine such as, but not limited to, a general purpose LLM hosted by a third party. In such an arrangement, the router 502 uses router control logic 510 to compose a search query generation prompt using the a query, user input, and search state data 512, or any combination thereof. The search query generation prompt is communicated to the external search query generative model and the one or more search queries 516 using an API of the external search query generative model.

In some examples, the utilization of a search query generative model 506 in an augmented search engine presents several features that enhance the search process and user experience. One of the features is the ability of the search query generative model 506 to refine and optimize user queries based on initial inputs and subsequent interactions. This optimization process provides for the search queries 516 to be precisely aligned with a user's intent, leading to more relevant and accurate search results. By understanding the nuances of user queries and incorporating additional information provided by users, the search query generative model 506 tailors the search queries in a way that improves the likelihood of retrieving information that meets the user's expectations.

In some examples, another feature is the capacity of the search query generative model 506 to handle a wide range of query complexities and domains. The search query generative model 506 is trained on a diverse dataset that includes various topics, query structures, and user interaction patterns. This training enables the search query generative model 506 to adapt to different user queries, regardless of their complexity or the specific domain they pertain to. As a specific example, the training results in model parameters within a complex machine-learning based model such as an LLM that are optimized to address a wide range of domains. In some embodiments, the breadth of applicability of the search query generative model 506 may be enabled using one or more sub-models that each feed output for the search query generative model 506. As a result, the augmented search engine becomes more versatile and capable of serving a broader user base with varying information requirements.

In some examples, the search query generative model 506 also contributes to a more efficient search process. By automatically generating optimized search queries (some of which may be provided back to a user), the model reduces the need for manual query refinement and speeds up the search initiation phase. This efficiency saves time for the users and enhances the overall performance of the augmented search engine by allowing it to process queries more quickly and respond to user requests in a timely manner.

In some examples, the use of a search query generative model 506 facilitates a more interactive and engaging search experience. The model's ability to generate queries based on user interactions, such as responses to clarifying questions, encourages users to engage more deeply with the search process. This interactive approach helps in refining the search queries and makes the search experience more personalized and user-centric. Users feel more involved in the search process, which can lead to higher satisfaction with the search outcomes.

In some examples, the implementation of a search query generative model 506 enhances the learning capabilities of an augmented search engine. As the search query generative model 506 processes more queries and interactions, those queries and interactions are fed back as training data, such that the search query generative model 506 continuously learns and improves its query generation capabilities. This ongoing learning process ensures that the search query generative model 506 remains up-to-date with evolving user behaviors and preferences, thereby maintaining its effectiveness over time. The adaptability of the search query generative model 506 and learning potential make the augmented search engine more robust and capable of meeting the changing requirements of its users.

In reference to FIG. 3 and FIG. 4, in operation 414, the augmented search engine 356 determines search results 348 by searching 346 one or more search indexes using the search query 344. For example, the router 330 communicates the search query 344 to an aggregator 334 of the augmented search engine 356. The aggregator 334 uses the search query 344 to search through one or more search indexes using one or more search engines, looking for information that matches the criteria set out in the search query 344. This step bridges the gap between the intent of the user 326 and a large amount of information available across various sources, guiding the search engine in its quest to provide the user 326 with accurate and relevant search results.

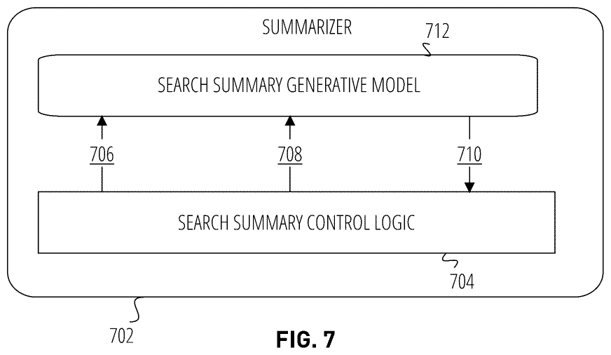

In reference to FIG. 6, in some examples, an aggregator 602 includes search control logic 610 executable by one or more processors that manages and controls a search based on one or more search queries provided by a router. In some examples, the aggregator 602 includes an external search engine interface 604 used to access search engines that are external to an augmented search engine. In some examples, the aggregator 602 functions as a central component within an augmented search engine, orchestrating the retrieval of information from various external search engines to satisfy a search query.

Upon receiving a search query that has been generated or refined by a search query generative model, the aggregator 602 initiates the search process by identifying the appropriate external search engines that are likely to yield relevant results for the given query. This determination is based at least in part on the nature of the query, the known strengths and specializations of available search engines, and possibly the user's search history or preferences. In some examples, the aggregator 602 uses search state data to determine which external search engines are to be queried.

In some examples, the aggregator 602 formulates search requests tailored to the query syntax and requirements of a selected external search engine. This may involve translating the search query into the specific format or query language used by an external search engine, as well as setting parameters or options that can influence the search results, such as the desired number of results, filters for content type, or geographical targeting. In some embodiments, each external search engine may have its own specific format and/or query language. In other embodiments, one or more external search engines utilize common format and/or queries languages.

Once the search queries are prepared, the aggregator 602 dispatches (or otherwise transmits data) the search queries to the respective external search engines through the external search engine interface 604 using web service or API interfaces provided by the external engines for programmatic access. In some examples, the aggregator 602 manages the search queries asynchronously, allowing multiple external searches to be conducted in parallel to reduce the overall response time.

As external search results 612 are returned (as data) from the external search engines, the aggregator 602 collects and aggregates them. This involves parsing the results, which may be in various formats depending on the external engine, and normalizing the formats of the returned search results 612 into a consistent structure for further processing. In some examples, the aggregator 602 may also deduplicate results that appear in multiple external engines, rank the aggregated results based on relevance to the query and other criteria (using a ranking algorithm), and apply additional filtering or categorization (using one or more filtering and categorization algorithms).

The aggregator 602 acts as an intermediary between the user and the external search engines, leveraging the specialized capabilities of an external engine to fulfill the search query in a comprehensive and efficient manner. By intelligently coordinating the search across multiple sources, the aggregator 602 enhances the depth and breadth of the search results available to the user, ultimately contributing to a more effective and satisfying search experience.

In some examples, the aggregator 602 uses an internal index search engine 606 to search an internal index maintained by an augmented search engine. This process provides quick and relevant search results from proprietary or curated content that the augmented search engine has access to. For example, upon receiving a search query as processed by other components of the augmented search engine, the aggregator 602 evaluates the query to determine its relevance to the content stored within the internal index. This evaluation is based on the nature of the query, including the topics, keywords, and any specific requirements or preferences indicated by the user. In some embodiments, results generated from the internal index search engine 606 may be aggregated with results from the one or more external search engines.

The aggregator 602 formulates a search request tailored to the internal index search engine. This involves translating the search query into a format or query language that is compatible with the internal index search engine. The aggregator 602 may also specify additional search parameters or options that can influence the search results, such as limiting the search to specified categories of content, specifying the desired number of results, or applying filters based on content attributes like date, authorship, or content type.

Once the search request is prepared, the aggregator 602 submits it to the internal index search engine 606. The internal index search engine 606 then executes the search against the internal index, which contains a structured repository of content that the augmented search engine has collected, organized, and indexed. This content may include documents, articles, multimedia files, and other types of information resources that are relevant to the search engine's domain of expertise or intended user base.

The internal index search engine retrieves the search results that match the query criteria from the internal index. These results are ranked based on their relevance to the search query, taking into account factors such as the presence and frequency of keywords, the recency of the content, and any other relevance signals that the internal index search engine 606 is configured to use.

The aggregator 602 effectively harnesses the capabilities of the internal index search engine 606 to provide rapid access to relevant, proprietary content within the augmented search engine's internal index, enhancing the overall search experience for the user by complementing external search results with pertinent content from the internal index.

The internal search results 614 from the internal index search engine 606 are then returned to the aggregator 602, which collects and integrates these results with any other results obtained from external search engines by the external search engine interface 604 or other sources. The aggregator 602 may perform additional processing on the aggregated results, such as deduplication, re-ranking, or categorization, to prepare a unified set of search results for presentation to the user.

In some examples, the aggregator 602 uses a ranking and filter model 608 to refine the external search results 612 and the internal search results 614 obtained from both internal and external search engines. The ranking and filter model 608 provides that the search results presented to the user are relevant and of high quality.

In some examples, the search results from different sources may be in various formats, the first task of the ranking and filter model 608 is to normalize these results into a consistent structure. This normalization process involves converting the metadata associated with a search result into a standard format that can be processed uniformly.

In some examples, the ranking and filter model 608 applies predefined filtering criteria to remove irrelevant, low-quality, or duplicate results. Filtering criteria can be based on various factors, such as the credibility of the source, the freshness of the content, user preferences, or specific content guidelines defined by an augmented search engine. This provides that pertinent results are considered for ranking.

In some examples, with a filtered set of results, the ranking and filter model 608 ranks search results based on their relevance to a query and the search results' overall quality. This ranking process considers a multitude of factors, including the presence and density of query terms within the content, the semantic relationship between the query terms and the content, user engagement metrics for similar queries, the authority and trustworthiness of the content source, and the recency of the content, especially for time-sensitive queries.

In some examples, the ranking and filter model 608 personalizes the search results based on a user's search history, preferences, and behavior. Personalization algorithms adjust the ranking of the results to better match the individual user's interests and past interactions with the search engine.

In reference to FIG. 3, in some examples, the aggregator 602 stores search results 348 in the search state database 332 as part of the search state data stored in the search state database 332 for use by other components of the augmented search engine 356.

At the conclusion of an operation 414, the router 330 transitions to operation 404 and makes a determination of whether a search has progressed to the point that one or more search queries 344 have been satisfied. For example, in reference to FIG. 5, a router 502 monitors search state data 512 stored in a search state database using a search state classification model 508 and determines that the augmented search has progressed to the point that the augmented search can enter a terminate search phase and search results can be summarized and presented to a user.

The search state classification model 508 is trained to generate a next search phase 514 indicating a terminate search phase in a process more fully described in reference to FIG. 8A and FIG. 8B. Training data used to train the search state classification model 508 to recognize that an augmented search is ready to enter a terminate search phase includes, but is not limited to:

Completed search sessions: A collection of search session data where the search successfully met the user's information requirements and was concluded without the need for further input or clarification. This data includes the query, any prompts and user responses, the search queries generated, and the search results that led to the termination of the search. Analyzing these completed sessions helps the model learn the characteristics of searches that are ready for termination.

User satisfaction indicators: Feedback from users indicating their satisfaction with the search results, such as ratings, comments, or the absence of further query refinement attempts after receiving the search results. This feedback serves as a direct indicator of the search's success and readiness for termination.

Search outcome annotations: Expert annotations on search sessions, categorizing them based on whether the search should be terminated or continued. These annotations provide a ground truth for the model, helping it to understand the criteria for deciding when a search is complete.

Query-result relevance scores: Data on the relevance of search results to the user's query, including metrics such as click-through rates, time spent on result pages, and relevance ratings. High relevance scores are indicative of successful searches that are candidates for termination.

Search progression data: Information capturing the progression of the search session, including the number of prompts generated, the number of user responses, and the evolution of the search query over time. This data helps the model recognize patterns in the search progression that typically lead to successful conclusions.

Contextual information: Contextual data related to the search, such as the time of day, the user's search history, and the device used for the search. This information can influence the decision to terminate a search, as certain contexts may be more conducive to concluding the search successfully.

NLP features: NLP features extracted from the search queries and user interactions, such as sentiment analysis, named entity recognition, and syntactic parsing. These features provide insights into the content and intent of the user's queries and responses, aiding the model in assessing the completeness of the search.

In some examples, using a search state classification model 508 to determine the appropriate phase of an augmented search process, such as when to enter a terminate search phase, offers several features that enhance the efficiency and effectiveness of the augmented search engine.

In some examples, the search state classification model 508 provides the feature of improved search efficiency. By accurately determining when a search has gathered sufficient information to meet the user's requirements, the search state classification model 508 prevents unnecessary search iterations. This efficiency saves time for both the user and the augmented search engine, allowing for a quicker resolution of queries.

In some examples, enhanced user satisfaction is another benefit offered by the search state classification model 508. Users benefit from receiving timely and relevant search results without the frustration of excessive or irrelevant prompts for additional information. The augmented search engine utilizes the search state classification model 508 to determine when a search is completed (as the search state classification model 508 is trained to identify completion of searching), and uses training data reflecting prompts and/or other search results to optimize a search experience for users by generating output in the form of additional prompts and/or search results that are likely to provide a desired output for the user. This responsiveness to user requirements can lead to a more positive search experience and increased trust in the augmented search engine.

In some examples, the search state classification model 508 also contributes to resource optimization within the augmented search engine. By streamlining the search process and reducing the need for additional computational resources to process unnecessary search steps (because the search state classification model 508 is trained to provide optimal results that require fewer search refinements—each of which requires substantial processing resources to complete, the search state classification model 508 helps in allocating resources more effectively. This optimization can be particularly beneficial in handling large volumes of queries or in resource-constrained environments.

In some examples, the search state classification model 508 enhances the adaptability of the augmented search engine. The search state classification model 508's ability to learn from user interactions and feedback allows it to continuously improve its decision-making regarding search termination. This adaptability ensures that the augmented search engine remains effective even as user behaviors and information landscapes evolve.

In some examples, another benefit provided by the search state classification model 508 is the generation of actionable insights. By analyzing search sessions and the criteria for their termination, the search state classification model 508 can identify patterns and trends in user queries and information requirements. These patterns and trends are reflected in the training data, even if not explicitly designated as such. Accordingly, by training the search state classification model 508 with prior data, the search state classification model 508 can inform further improvements to the augmented search engine, such as refining search algorithms or enhancing user interfaces.

In some examples, the search state classification model 508 also offers the benefit of reducing information overload for users. By determining the optimal point to terminate a search based on the trained model encompassing the search state classification model 508, the search state classification model 508 ensures that users are presented with a concise and relevant set of search results, either via a visual users interface or an audio output. This focus on quality over quantity helps users in making informed decisions more efficiently.

In some examples, the search state classification model 508 contributes to the overall effectiveness of the augmented search engine. By ensuring that searches are concluded when appropriate, the search state classification model 508 supports the delivery of accurate and relevant search results. This effectiveness is useful for maintaining the utility and reliability of the augmented search engine as a tool for information retrieval.

Referring to FIG. 3 and FIG. 4, in response to determining that the search has progressed to the point that the search results 348 may be summarized and presented to the user 326, in operation 416, the router 330 enters a terminate search phase 424 and initiates 350 generation 354 of a search summary 352 by a summarizer 336.

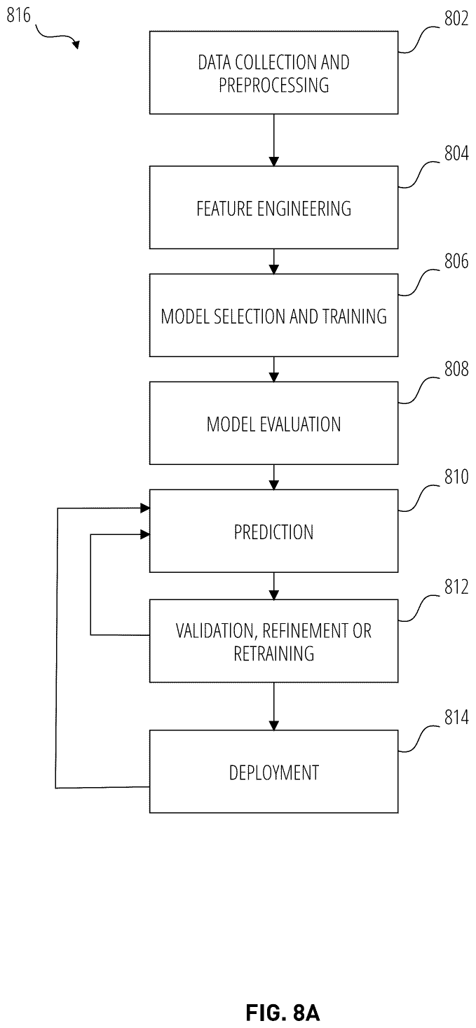

In response to a request from the router 330, the summarizer 336 retrieves search state data 358 from the search state database 332 and initiates generation of the search summary 352. For example, referring to FIG. 7, a summarizer 702 includes a search summary generative model 712 and search summary control logic 704 to generate a search summary 352 (of FIG. 3). The search summary control logic 704 generates a set of instructions 706 that are provided as part of the context of the search summary generative model 712. The instructions 706 include formatting instructions for generating a summary of data of a search state data 708 of a search that has been completed. The search state data 708 is a dataset stored on the search state database 332 (of FIG. 3) by the various components of an augmented search engine during a search. At the completion of a search, the search state data 708 includes search results generated by an aggregator 334 (of FIG. 3) and the router 330 (of FIG. 3). The search state database 332, utilized by both the router 330 and the aggregator 334, stores a variety of data elements used for managing and optimizing the search process. The types of search state data that may be stored include:
Original Query: The initial query submitted by the user, serving as the starting point for the search process.
Prompts: Details of any prompts generated by the router 330 to request additional information from the user, if the initial query is deemed ambiguous or insufficiently detailed.
User Input: Any additional information or clarifications provided by the user in response to the prompts.
Optimized Search Queries: The refined or reformulated search queries, based on the original query and any additional user input, designed to retrieve relevant search results.
Search Results: The results obtained from querying the internal and external search indexes, including metadata such as source, ranking, and any applied filters.
User Interactions with Search Results: Data capturing how users interact with the search results, such as clicks, dwell time, and feedback, used for assessing relevance and quality.
Contextual Information: Data related to the search session, including the device used, location, time of the search, and any other environmental or situational factors.
State of the Search: Information capturing the sequence of actions taken during the search, changes to search parameters, and the status of the search at various stages.

In some examples, the search results 348 include the results themselves and also metadata such as the source of the results, the ranking of the search results, and any filtering or categorization applied.

In some examples, data indicative of user interactions with these search results, such as time spent on a result, and any feedback provided, are recorded and stored as search state data. This interaction data is used for assessing the relevance and quality of the search results and for making adjustments to improve future search outcomes.

In some examples, the search state data may include contextual information related to the search session. This encompasses data about a location of the compact search client 328 (of FIG. 3) and the user 326 (of FIG. 3), a time of the search, and any other environmental or situational factors that could influence the search process. Contextual information helps in tailoring the search experience to the specific requests and circumstances of the user 326.

In some examples, the compact search client 328 communicates metadata to the augmented search engine 356 as part of the data of one or more queries 372 (of FIG. 3) and/or one or more responses 342. The metadata is stored in the search state database 332 as part of the search state data 358. The metadata may include, but is not limited to:

Compact search client ID and Timestamps: In some examples, the compact search client transmits a unique identifier with each query, allowing the backend to track requests and responses for specific compact search clients. The compact search client sends timestamps with each query to enable logging and to provide responses that are sensitive to the time of day.

Location Data: In some examples, the compact search client uploads its location data, enabling the backend to deliver location-specific answers.

Battery Level: In some examples, the compact search client reports its current battery level, which the backend uses to adjust interactions, potentially simplifying responses to conserve power when the battery is low.

Connection Quality: In some examples, the compact search client provides information about the Wi-Fi or Bluetooth connection quality, which assists in troubleshooting issues or optimizing data transmission based on the connection speed.

User Preferences and History: In some examples, the compact search client may track and send user preferences or past queries, allowing the backend to personalize responses based on individual user behaviors or interests.

Audio Quality Metrics: In some examples, the compact search client sends metrics related to audio quality, such as volume levels and clarity, to enhance voice recognition capabilities on the backend.

Gesture and Button Use: In some examples, the compact search client records and transmits data on the frequency and context of physical button uses or gestures, providing insights that could inform device design improvements or user interface updates.

In some examples, the search state data may capture the state of the search at various checkpoints. This includes the sequence of actions taken during the search, any changes to the search parameters, and the status of the search at different stages. Storing the state of the search allows for the resumption of interrupted search sessions and provides insights into the search process's dynamics.

Training of the search summary generative model 712 is more fully described in reference to FIG. 8A and FIG. 8B. Training data used to train the search summary generative model 712 encompasses a variety of elements designed to enable the model to generate concise, relevant, and informative summaries of search results. This training data includes, but is not limited to:
Search queries and results: Pairs of search queries and the corresponding search results, including titles, snippets, and URLs. This data helps the model learn how to extract key information relevant to the query from the search results.
User-generated summaries: Human-written summaries for sets of search results related to specific queries. These summaries serve as examples of how to condense and highlight pertinent information from search results.
Relevance feedback: Data on which search results users found useful for given queries, including click-through rates and user ratings. This feedback can guide the model in identifying which aspects of search results are pertinent to users.
Query-result relationships: Annotations describing the relationship between search queries and individual search results, such as relevance scores or categorizations. This helps the model understand the significance of different results in relation to the query.
Natural language annotations: Semantic annotations of search results and summaries, including named entity recognition, part-of-speech tagging, and sentiment analysis. These annotations aid the model in understanding the linguistic structure and meaning of the text.
Summarization techniques: Examples of different summarization techniques, such as extractive summarization (selecting key phrases or sentences from the original text) and abstractive summarization (rewriting the essence of the text in new words). Training on a variety of techniques enables the model to adopt an effective approach for summarizing search results.
Contextual information: Data about the context in which queries are made, such as the user's search history, the time of the query, and the device used. This information can help the model tailor summaries to the user's specific context and preferences.
Cross-domain content: Search results and summaries from a wide range of domains and topics. Training on diverse content ensures that the model can generate accurate and relevant summaries across different subject areas.

The training data is used to train the search summary generative model 712 to synthesize information from search results into coherent, informative summaries that capture the essence of the results in relation to the user's query. This process enhances the user's search experience by training the search summary generative model 712 to provic quick insights into the content of search results in the form of output (e.g., visual output in the form of text and/or images, or audio output).

In some examples, a search summary generative model 712 is external to an augmented search engine such as, but not limited to, a general purpose LLM hosted by a third party. In such an arrangement, the summarizer 702 uses search summary control logic 704 to compose a summary generation prompt or message using the instructions 706 and the search state data 708. The summary generation prompt is communicated to the external search summary generative model and the search summary 710 is received from the external search summary generative model using an API of the external search summary generative model.

In some examples, using a search summary generative model 712 to generate a summary of search results in an augmented search offers the benefit of improved user comprehension of search results. The search summary generative model 712 can synthesize complex and voluminous search results into concise summaries, aiding users in quickly understanding the essence of the search results without needing to sift through each result individually. In some implementations, the concise summaries may be structured in a manner desired by the user, for example, if the user provided a prompt instructing how the summary should be conveyed. The user may specify a reading comprehension level for providing the summary, or may specify that the summary should be provided by explaining the results in way that compares them to another concept (e.g., explain the search results by using examples based on fairy tale characters). In such instances, the search summary generative model 712 utilizes insighted provided by the voluminous training data to provide the output that conforms with the user's stated manner for summarizing. This facilitates easier and faster comprehension of the search outcomes.

In some examples, the search summary generative model 712 enhances the user experience by providing summaries that capture the pertinent information from a broad set of search results. Users can quickly grasp the relevance of the search results to their query, leading to higher satisfaction with the search process and potentially increasing the likelihood of users returning to the augmented search engine for future information requirements.

In some examples, the search summary generative model 712 contributes to time and resource efficiency. It streamlines the search process by reducing the time users spend analyzing individual search results. This efficiency benefits users and optimizes the use of computational resources within the augmented search engine, as the model automates the summarization process that would otherwise require significant manual effort and processing power.

In some examples, the search summary generative model 712 allows for customization and personalization. It can be trained to generate summaries tailored to specific user preferences or query contexts. By learning from user interactions and feedback, the search summary generative model 712 can adapt its summarization techniques to better align with individual user requirements or preferences, offering a more personalized search experience.

In some examples, the scalability of the search summary generative model 712 ensures that the augmented search engine can effectively serve a broad user base with varying information requirements, from simple queries to complex research topics. This scalability is useful for handling a wide range of queries and generating summaries for diverse sets of search results.

In some examples, the search summary generative model 712 maintains quality control and consistency in the summaries it generates. This ensures that users receive reliable and coherent information regardless of the query, which is useful for building user trust in the augmented search engine's ability to provide valuable and accurate summaries.

In some examples, the search summary generative model 712 is designed to extract and highlight insights, trends, or patterns within the search results, adding value by summarizing the content and by providing users with actionable insights derived from the aggregated search results.

In some examples, the search summary generative model 712 effectively reduces information overload for users by condensing the search results into summaries. This reduction helps users focus on the relevant information, making the search process more manageable and less overwhelming.

Referring to FIG. 4, in operation 418, the augmented search engine 356 provides the search summary 352 to the user 326 as a verbal search summary 396 via the compact search client 328. For example, the summarizer 336 communicates the search summary 352 to the router 330. The router 330 communicates the search summary 352 to the NLP pipeline 370. The NLP pipeline 370 receives the search summary 352 and generates data of an audio search summary 392 comprised of a digital audio signal of the search summary 352 using NLP methodologies as previously described. The router 330 communicates the audio search summary 392 to the compact search client 328. The compact search client 328 receives the audio search summary 392 and converts the digital audio signal of the audio search summary 392 into a verbal search summary 396 comprised of an audio signal provided to the user 326 using a DAC of a microcontroller 202 (of FIG. 2), an audio amplifier 208 (of FIG. 2) and a speaker 210 (of FIG. 2).

MACHINE-LEARNING PIPELINE

FIG. 8B is a flowchart depicting a machine-learning pipeline 816, according to some examples. The machine-learning pipeline 816 may be used to generate a trained machine-learning model 818 (e.g., a search state classification model 508 (of FIG. 5), a prompt generative model 504 (of FIG. 5), a search query generative model 506 (of FIG. 5), a search summary generative model 712 (of FIG. 7), a speech-to-text machine learning model, a text-to-speech machine learning model, and the like) to perform operations associated with searches, user responses to prompts, and search summaries.

Machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 818 may include multiple phases that form part of the machine-learning pipeline 816, including for example the following phases illustrated in FIG. 8A:
Data collection and preprocessing 802: This phase may include acquiring and cleaning data to ensure that it is suitable for use in the machine learning model. This phase may also include removing duplicates, handling missing values, and converting data into a suitable format.
Feature engineering 804: This phase may include selecting and transforming the training data 822 to create features that are useful for predicting the target variable. Feature engineering may include (1) receiving features 824 (e.g., as structured or labeled data in supervised learning) and/or (2) identifying features 824 (e.g., unstructured or unlabeled data for unsupervised learning) in training data 822.
Model selection and training 806: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 808: This phase may include evaluating the performance of a trained model (e.g., the trained machine-learning model 818) on a separate testing dataset. This phase can help determine if the model is overfitting or underfitting and determine whether the model is suitable for deployment.
Prediction 810: This phase involves using a trained model (e.g., trained machine-learning model 818) to generate predictions on new, unseen data.
Validation, refinement or retraining 812: This phase may include updating a model based on feedback generated from the prediction phase, such as new data or user feedback.
Deployment 814: This phase may include integrating the trained model (e.g., the trained machine-learning model 818) into a more extensive system or application, such as a web service, mobile app, or IoT device. This phase can involve setting up APIs, building a user interface, and ensuring that the model is scalable and can handle large volumes of data.

FIG. 8B illustrates further details of two example phases, namely a training phase 820 (e.g., part of the model selection and trainings 806) and a prediction phase 826 (part of prediction 810). Prior to the training phase 820, feature engineering 804 is used to identify features 824. This may include identifying informative, discriminating, and independent features for effectively operating the trained machine-learning model 818 in pattern recognition, classification, and regression. In some examples, the training data 822 includes labeled data, known for pre-identified features 824 and one or more outcomes. Any of the features 824 may be a variable or attribute, such as an individual measurable property of a process, article, system, or phenomenon represented by a data set (e.g., the training data 822). Features 824 may also be of different types, such as numeric features, strings, and graphs, and may include one or more of content 828, concepts 830, attributes 832, historical data 834, and/or user data 836, merely for example.

In training phase 820, the machine-learning pipeline 816 uses the training data 822 to find correlations among the features 824 that affect a predicted outcome or prediction/inference data 838.

With the training data 822 and the identified features 824, the trained machine-learning model 818 is trained during the training phase 820 during machine-learning program training 840. The machine-learning program training 840 appraises values of the features 824 as they correlate to the training data 822. The result of the training is the trained machine-learning model 818 (e.g., a trained or learned model).

Further, the training phase 820 may involve machine learning, in which the training data 822 is structured (e.g., labeled during preprocessing operations). The trained machine-learning model 818 implements a neural network 842 capable of performing, for example, classification and clustering operations. In other examples, the training phase 820 may involve deep learning, in which the training data 822 is unstructured, and the trained machine-learning model 818 implements a deep neural network 842 that can perform both feature extraction and classification/clustering operations.

In some examples, a neural network 842 may be generated during the training phase 820, and implemented within the trained machine-learning model 818. The neural network 842 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 842 operationally computes a function, such as an activation function, which takes as input the weighted sum of the outputs of the neurons in the previous layer, as well as a bias term. The output of this function is then passed as input to the neurons in the next layer. If the output of the activation function exceeds a specified threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 842 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 820, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 826, the trained machine-learning model 818 uses the features 824 for analyzing query data 844 to generate inferences, outcomes, or predictions, as examples of a prediction/inference data 838. For example, during prediction phase 826, the trained machine-learning model 818 generates an output. Query data 844 is provided as an input to the trained machine-learning model 818, and the trained machine-learning model 818 generates the prediction/inference data 838 as output, responsive to receipt of the query data 844.

In some examples, the trained machine-learning model 818 may be a generative AI model. Generative AI is a term that may refer to any type of artificial intelligence that can create new content from training data 822. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 844 may include text, audio, image, video, numeric, or media content prompts and the output prediction/inference data 838 includes text, images, video, audio, code, or synthetic data.

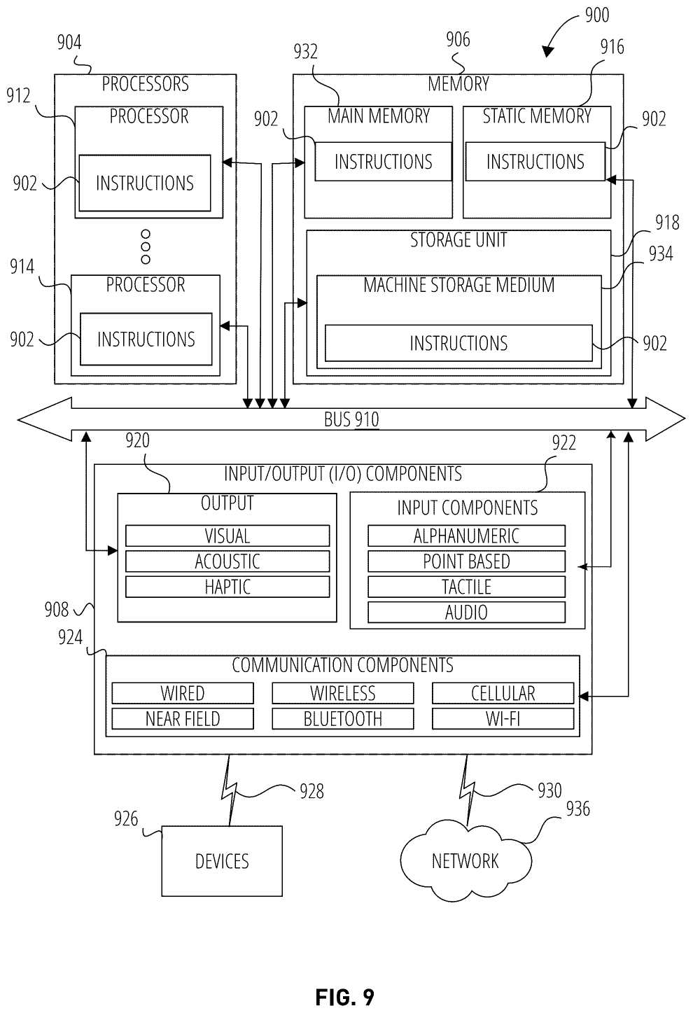

FIG. 9 illustrates a diagrammatic representation of a machine 900 in the form of a computing system within which a set of instructions may be executed for causing the machine 900 to perform any one or more of the methodologies discussed herein, according to examples. Specifically, FIG. 9 shows a diagrammatic representation of the machine 900 in the example form of a computer system, within which instructions 902 (e.g., software, a program, an application, an applet, an application, or other executable code) for causing the machine 900 to perform any one or more of the methodologies discussed herein may be executed. For example, the instructions 902 may cause the machine 900 to execute any one or more operations of any one or more of the methods described herein. In this way, the instructions 902 transform a general, non-programmed machine into a particular machine 900 (e.g. a host for an augmented search engine, a host for a client, a host for a search engine, or a host for a generative model) that is specially configured to carry out any one of the described and illustrated functions in the manner described herein.

In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein.

The machine 900 includes hardware processors 904, memory 906, and I/O components 908 configured to communicate with each other such as via a bus 910. In some examples, the processors 904 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 912 and a processor 914 that may execute the instructions 902. The term “processor” is intended to include multi-core processors that may comprise two or more independent processors (sometimes referred to as “cores”) that may execute instructions 902 contemporaneously. Although FIG. 9 shows multiple processors 904, the machine 900 may include a single processor with a single core, a single processor with multiple cores (e.g., a multi-core processor), multiple processors with a single core, multiple processors with multiple cores, or any combination thereof.

The memory 906 may include a main memory 932, a static memory 916, and a storage unit 918 including a machine storage medium 934, accessible to the processors 904 such as via the bus 910. The main memory 932, the static memory 916, and the storage unit 918 store the instructions 902 embodying any one or more of the methodologies or functions described herein. The instructions 902 may also reside, completely or partially, within the main memory 932, within the static memory 916, within the storage unit 918, within at least one of the processors 904 (e.g., within the processor's cache memory), or any suitable combination thereof, during execution thereof by the machine 900.

The input/output (I/O) components 908 include components to receive input, provide output, produce output, transmit information, exchange information, capture measurements, and so on. The specific I/O components 908 that are included in a particular machine 900 will depend on the type of machine. For example, portable machines such as mobile phones will likely include a touch input device or other such input mechanisms, while a headless server machine will likely not include such a touch input device. It will be appreciated that the I/O components 908 may include many other components that are not shown in FIG. 9. The I/O components 908 are grouped according to functionality merely for simplifying the following discussion and the grouping is in no way limiting. In various examples, the I/O components 908 may include output components 920 and input components 922. The output components 920 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 922 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 908 may include communication components 924 operable to couple the machine 900 to a network 936 or devices 926 via a coupling 930 and a coupling 928, respectively. For example, the communication components 924 may include a network interface component or another suitable device to interface with the network 936. In further examples, the communication components 924 may include wired communication components, wireless communication components, cellular communication components, and other communication components to provide communication via other modalities. The devices 926 may be another machine or any of a wide variety of peripheral devices (e.g., a peripheral device coupled via a universal serial bus (USB)). For example, as noted above, the machine 900 may correspond to any one of a host for an augmented search engine, a client of an augmented search engine, and the like.

The various memories (e.g., 906, 916, 932, and/or memory of the processor(s) 904 and/or the storage unit 918) may store one or more sets of instructions 902 and data structures (e.g., software) embodying or utilized by any one or more of the methodologies or functions described herein. These instructions 902, when executed by the processor(s) 904, cause various operations to implement the disclosed examples.

Described implementations of the subject matter can include one or more features, alone or in combination as illustrated below by way of example:

Example 1 is a method comprising: receiving, by a compact search client, a verbal query from a user; communicating, by the compact search client, the verbal query to an augmented search engine as an audio query; receiving, by the augmented search engine from the compact search client, the audio query for a search; generating, by the augmented search engine, a search query using the audio query and a speech-to-text machine learning model; determining, by the augmented search engine, search results using the search query; generating, by the augmented search engine, a search summary using the search results; generating, by the augmented search engine, an audio search summary using the search summary and a text-to-speech machine learning model; communicating, by the augmented search engine, the audio search summary to the compact search client; receiving, by the compact search client from the augmented search engine, the search summary as an audio search summary; and providing the audio search summary to the user as an audio signal.

In Example 2, the subject matter of Example 1 includes, storing, by the augmented search engine, the query in a search state database; determining, by the augmented search engine, a next search phase using the search state database; and in response to determining the next search phase is a search phase of requesting additional user input, performing operations comprising: generating, by the augmented search engine, an audio prompt for the user using the search state database; and communicating, by the augmented search engine to the compact search client, the audio prompt; receiving, by the compact search client from the augmented search engine, the audio prompt; providing, by the compact search client to the user, the audio prompt as an audio signal; receiving, by the compact search client, a verbal response from the user; communicating, by the compact search client to the augmented search engine, the verbal response to the augmented search engine as an audio response; and receiving, by the augmented search engine from the compact search client, the audio response in response to the audio prompt.

In Example 3, the subject matter of any of Examples 1-2 includes, wherein determining a next search phase further comprises using a search state classification model.

In Example 4, the subject matter of any of Examples 1-3 includes, wherein generating the prompt further comprises using a Large Language Model (LLM).

In Example 5, the subject matter of any of Examples 1-4 includes, wherein generating the search query further comprises using an LLM.

In Example 6, the subject matter of any of Examples 1-5 includes, wherein generating the search summary further comprises using an LLM.

In Example 7, the subject matter of any of Examples 1-6 includes, wherein the determining of the search results using the search query comprises using an internal index.

In Example 8, the subject matter of any of Examples 1-7 includes, wherein the determining of the search results using the search query comprises using an external search engine.

Example 9 is a method comprising: receiving, from a compact search client, an audio query for a search, the audio query generated by the compact search client using a verbal query received from a user; generating a search query using the audio query and a speech-to-text machine learning model; determining search results using the search query; generating a search summary using the search results; generating an audio search summary using the search summary and a text-to-speech machine learning model; communicating the audio search summary to the compact search client, the audio search summary received by the compact search client and provided to the user as an audio signal.

In Example 10, the subject matter of Example 9 includes, storing the query in a search state database; determining a next search phase using the search state database; and in response to determining the next search phase is a search phase of requesting additional user input, performing operations comprising: generating an audio prompt for the user using the search state database; communicating the audio prompt to the compact search client, the audio prompt received by the compact search client and provided to the user as an audio signal; and receiving, from the compact search client, an audio response, the audio response received as a verbal response from the user in response to the audio prompt.

Example 11 is a method comprising: receiving a verbal query for a search from a user; communicating the verbal query to an augmented search engine as an audio query; receiving, from the augmented search engine, an audio search summary, the audio search summary generated using a search summary and a text-to-speech machine learning model, the search summary generated using search results determined by a search query, the search query determined using the audio query and a speech-to-text machine learning model; and providing the audio search summary to the user as an audio signal.

In Example 12, the subject matter of Example 11 includes, receiving, from the augmented search engine, an audio prompt, the audio prompt generated for the user using a search state database including the search query, the audio prompt generated in response to determining a next search phase is a search phase of requesting additional user input; providing, to the user, the audio prompt as an audio signal; receiving a verbal response from the user; and communicating, to the augmented search engine, the verbal response as an audio response.

Example 13 is at least one machine-readable medium including instructions that, when executed by processing circuitry, cause the processing circuitry to perform operations to implement of any of Examples 1-12.

Example 14 is an apparatus comprising means to implement of any of Examples 1-12.

Example 15 is a system to implement of any of Examples 1-12.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., crasable programmable read-only memory (EPROM), electrically crasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 936 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 936 or a portion of the network 936 may include a wireless or cellular network, and the coupling 930 may be a Code Division Multiple Access (CDMA) connection, a Global System for Mobile communications (GSM) connection, or another type of cellular or wireless coupling. In this example, the coupling 930 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 902 may be transmitted or received over the network 936 using a transmission medium via a network interface device (e.g., a network interface component included in the communication components 924) and utilizing any one of a number of well-known transfer protocols (e.g., hypertext transfer protocol (HTTP)). Similarly, the instructions 902 may be transmitted or received using a transmission medium via the coupling 928 (e.g., a peer-to-peer coupling) to the devices 926. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 902 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of the operations may be distributed among the one or more processors, residing within a single machine or deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

1. A system comprising a memory and at least one processor configured to:
receive an audio query of a verbal input captured by a microphone of a compact search client;
generate a search query based at least in part on output of a speech-to-text machine learning model using the audio query as input;
generate a search summary based at least in part on search results determined from the search query;
convert the search summary into an audio search summary using a text-to-speech machine learning model; and
communicate, over a network, the audio search summary to the compact search client to cause the compact search client to output the audio search summary using an audio speaker.

2. The system of claim 1, wherein the at least one processor are configured to:
store the search query in a search state database;
determine, using the search state database, that additional user input is needed to determine the search results;
generate an audio prompt;
communicate, over the network, the audio prompt to the compact search client to cause the compact search client to output the audio prompt using the audio speaker.

3. The system of claim 2, wherein to determine that additional user input is needed to determine the search results, the at least one processor executes a search state classification model.

4. The system of claim 2, wherein generating the audio prompt comprises executing a Large Language Model (LLM).

5. The system of claim 1, wherein generating the search query comprises executing a Large Language Model (LLM).

6. The system of claim 1, wherein generating the search summary comprises executing a Large Language Model (LLM).

7. The system of claim 1, wherein generating the search summary comprises determining the search results using an internal index.

8. The system of claim 1, wherein generating the search summary comprises determining the search results at least in part by querying an external search engine and receiving output from the external search engine.

9. A method comprising:
receiving, by at least one processor, an audio query of a verbal input captured by a microphone of a compact search client;
generating, by the at least one processor, a search query based at least in part on output of a speech-to-text machine learning model using the audio query as input;
generating, by the at least one processor, a search summary based at least in part on search results determined from the search query;
converting, by the at least one processor, the search summary into an audio search summary using a text-to-speech machine learning model; and
communicating, over a network, the audio search summary to the compact search client to cause the compact search client to output the audio search summary using an audio speaker.

10. The method of claim 9, further comprising:
storing the search query in a search state database;
determining, using the search state database, that additional user input is needed to determine the search results;
generating an audio prompt;
communicating, over the network, the audio prompt to the compact search client to cause the compact search client to output the audio prompt using the audio speaker;
receiving an audio response generated by the compact search client based at least in part on a verbal response captured by a microphone after the compact search client output the audio prompt using the audio speaker; and
wherein generating the search query is further based at least in part on output of the speech-to-text machine learning model using the audio query and the audio response as input.

11. The method of claim 10, wherein determining that additional user input is needed to determine the search results comprises executing a search state classification model.

12. The method of claim 10, wherein generating the audio prompt comprises executing a Large Language Model (LLM).

13. The method of claim 9, wherein generating the search query comprises executing a Large Language Model (LLM).

14. The method of claim 9, wherein generating the search summary comprises executing a Large Language Model (LLM).

15. The method of claim 9, wherein generating the search summary comprises determining the search results using an internal index.

16. The method of claim 9, wherein generating the search summary comprises determining the search results at least in part by querying an external search engine and receiving output from the external search engine.

17. A method comprising:
capturing a verbal query for a search using a microphone;
communicating audio data of the verbal query over a network to an augmented search engine to cause the augmented search engine to generate a search query using a speech-to-text machine learning model;
receiving, from the augmented search engine, an audio search summary, the audio search summary generated using a search summary and a text-to-speech machine learning model, the search summary generated using search results determined by the search query; and
generating an audio signal for the audio search summary using an audio speaker.

18. The method of claim 17 further comprising:
receiving, from the augmented search engine, an audio prompt requesting additional user input, the audio prompt generated for the user using a search state database including the search query;
generating an audio signal for the audio prompt using the audio speaker;
capturing a verbal response using the microphone; and
communicating an audio response of the verbal response, to the augmented search engine over the network.

19. The method of claim 18, wherein communicating the audio response occurs before receiving the audio search summary, and wherein the search query is generated based at least in part on the audio response.
